(19) United States
(12) Patent Application Publication
(10) Pub. No.: US 2026/0181268 A1
(43) Pub. Date: Jun. 25, 2026

(54) IMAGE CAPTURE CONTROL APPARATUS, CONTROL METHOD THEREFOR, AND MULTI-CAMERA IMAGE CAPTURE SYSTEM

(71) Applicant: CANON KABUSHIKI KAISHA, Tokyo (JP)

(72) Inventor: MASASHI NISHIYAMA, Kanagawa (JP)

(21) Appl. No.: 19/424,598

(22) Filed: Dec. 18, 2025

(30) Foreign Application Priority Data
Dec. 25, 2024 (JP) 2024-229384

(51) Int. Cl. H04N 23/90; H04N 23/60; H04N 23/611; H04N 23/69; H04N 23/695

(52) U.S. Cl. CPC H04N 23/90; H04N 23/611; H04N 23/64; H04N 23/69; H04N 23/695

(57) ABSTRACT

An image capture control apparatus that controls an image capture operation of a sub camera from among a plurality of cameras including a main camera and one or more sub cameras, is disclosed. The apparatus selectively executes, based on information relating to the main camera, first control including automatically controlling one or more of an image capture direction and an angle of view of a sub camera based on a state of the main camera or a video captured by the main camera, and second control including automatically controlling one or more of the image capture direction and the angle of view of the sub camera not based on the state of the main camera and the video captured by the main camera.

### BACKGROUND

### Field of the Technology

The present disclosure relates to an image capture control apparatus, a control method therefor, and a multi-camera image capture system, and in particular relates to technology for automatic control of image capture operations of an image capture apparatus.

### Description of the Related Art

There is a multi-camera image capture system that, during live streaming and recording, uses a video switcher to dynamically select or switch the video that is to be used in streaming or recording (main video) from among videos captured in parallel by a plurality of cameras (Japanese Patent Laid-Open No. 2022-45529).

In such a multi-camera image capture system, for example, if the image capture operation of one camera (sub camera) is automatically controlled on the basis of information obtained from another camera (main camera), a problem may occur. Specifically, in a case where the image capture direction and angle of view of the main camera is changed while the video captured by the sub camera is selected via the video switcher, if the image capture direction and angle of view of the sub camera changes in conjunction with this change, the video selected by the video switcher may change to an unintended video.

### SUMMARY

In some embodiments according to the present disclosure, an image capture control apparatus configured to appropriately control the linking of a plurality of cameras in a multi-camera image capture system, and a control method for the image capture control apparatus are provided.

According to an aspect of the present disclosure, there is provided an image capture control apparatus that controls an image capture operation of a sub camera from among a plurality of cameras including a main camera and one or more sub cameras, comprising: one or more processors that execute a program stored in a memory, wherein the program includes instructions that, when the program is executed by the one or more processors, cause the one or more processors to: selectively execute, based on information relating to the main camera, first control including automatically controlling one or more of an image capture direction and an angle of view of a sub camera based on a state of the main camera or a video captured by the main camera, and second control including automatically controlling one or more of the image capture direction and the angle of view of the sub camera not based on the state of the main camera and the video captured by the main camera.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic view of an image capture system according to a first embodiment.

FIG. 2 is a block diagram illustrating an example of the functional configuration of each apparatus of the image capture system according to the first embodiment.

FIG. 3 is a diagram of an image capture control apparatus according to the first embodiment focusing on main operations and the flow of signals.

FIG. 4 is a diagram illustrating an example of roles that can be set for a sub camera and control content according to the first embodiment.

FIG. 5 is a flowchart relating to role determination processing according to the first embodiment.

FIGS. 6A to 6D are flowcharts relating to operations of each apparatus of the image capture system according to the first embodiment.

FIGS. 7A and 7B are diagrams for describing coordinate conversion according to the first embodiment.

FIGS. 8A and 8B are diagrams relating to subject detection and coordinate conversion according to the first embodiment.

FIGS. 9A to 9C are schematic views of operation control of a sub camera according to the first embodiment.

FIGS. 10A to 10C are schematic views of another operation control of a sub camera according to the first embodiment.

FIG. 11 is a diagram for describing pan value calculation according to the first embodiment.

FIG. 12 is a diagram for describing tilt value calculation according to the first embodiment.

FIG. 13 is a diagram illustrating a mapping example of zoom values of a main camera and a sub camera according to the first embodiment.

FIG. 14 is a flowchart relating to a characteristic operation of the image capture control apparatus according to the first embodiment.

FIG. 15 is a flowchart relating to a characteristic operation of an image capture control apparatus according to a second embodiment.

FIGS. 16A to 16C are timing charts illustrating linked statuses of the image capture control apparatus according to the second embodiment.

FIG. 17 is a flowchart relating to a characteristic operation of an image capture control apparatus according to a third embodiment.

FIG. 18 is a schematic view for describing a composition selection operation according to the third embodiment.

FIG. 19 is a flowchart relating to a characteristic operation of an image capture control apparatus according to a fourth embodiment.

FIG. 20 is a timing chart illustrating linked statuses of the image capture control apparatus according to the fourth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Overview of Multi-Camera Image Capture System

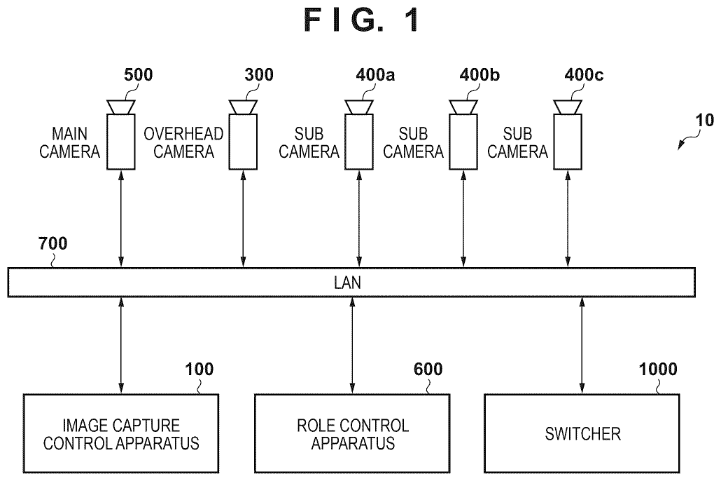

FIG. 1 is a schematic view illustrating an example of the configuration of a multi-camera image capture system 10 (hereinafter simply referred to as an image capture system) according to the present embodiment. The image capture system 10 includes a plurality of cameras 300, 400a to 400c, and 500, an image capture control apparatus 100, a role control apparatus 600, and a video switcher 1000 (hereinafter simply referred to as switcher 1000). The plurality of cameras 300, 400a to 400c, and 500, the image capture control apparatus 100, the role control apparatus 600, and the switcher 1000 are communicatively connected to one another via a communication network 700.

The communication network 700 is compliant with a known wired or wireless communication standard such as the IEEE 802.3 series and the IEEE 802.11 series. Also, each of the plurality of cameras 300, 400a to 400c, and 500, the image capture control apparatus 100, the role control apparatus 600, and the switcher 1000 include a communication interface compliant with the standard of the communication network 700.

Of the plurality of cameras 300, 400a to 400c, and 500, the camera 300 captures images of the entire predetermined captured area. The captured area is set as an area in a studio in which an image capture main subject may be present, for example. Thus, in the video of the camera 300, all of the subject in the captured area is captured. Note that in the specification, “a/the video of a/the camera XXX” refers to “a/the video captured or output by a/the camera XXX”, rather than a/the video capturing a/the camera XXX.

The purpose of the camera 300 is to capture video for detecting the subject (for example, a person) that is the image capture target in the captured area. Thus, the image capture direction and the angle of view of the camera 300 is determined according to the position and captured area of the camera 300, and this is basically fixed during image capture. Also, the camera 300 preferably captures the entire of the captured area without anything being hidden by an object from outside of the captured area. In order to distinguish the camera 300 from the other cameras 400a to 400c and 500 which are basically not fixed in terms of the image capture direction and angle of view during image capture, the camera 300 may be referred to as an overhead camera below. However, the installation position of the overhead camera 300 is not limited to a position overhead of the captured area. The operation of the overhead camera 300 can be controlled from the image capture control apparatus 100.

The cameras 400a to 400c and 500 are PTZ cameras, for example, and operations including image capture direction (pan and tilt angle) and angle of view (zoom) can be controlled from an external apparatus. Here, the operation of the camera 500 is controlled by a user of the image capture system, and the operations of the cameras 400a to 400c are controlled by the image capture control apparatus 100. Hereinafter, since the operations of the cameras 400a to 400c are controlled by the image capture control apparatus 100 on the basis of the state of the camera 500, the camera 500 may be referred to as a main camera and the cameras 400a to 400c may be referred to as sub cameras. To facilitate description and understanding, FIG. 1 illustrates an example of the three sub cameras 400a to 400c. However, it is sufficient that the number of sub cameras is one or more. Hereinafter, the sub cameras 400a to 400c may be collectively referred to as sub cameras 400, and items and operations that are the same across the sub cameras 400a to 400c may be referred to as items and operations of the sub camera 400.

Note that the main camera 500 may be operated automatically or by a user from the image capture control apparatus 100 or remotely from another remote control apparatus, or there may be a user that directly operates the main camera 500. Also, the sub cameras 400 and the main camera 500 may each have their camera body attached to a head, allowing for control of the image capture direction (pan and tilt angle). Also, the sub cameras 400 and the main camera 500 may be mounted with an interchangeable zoom lens on the camera body.

Here, in the present embodiment, for the role control apparatus 600 and the switcher 1000, a user is present. Also, for the image capture control apparatus 100, a user is not required but may be present. Also, the same user may operate two or more of the role control apparatus 600, the image capture control apparatus 100, and the switcher 1000. Image capture with the overhead camera 300 and the sub cameras 400 does not require a user since control is performed by the image capture control apparatus 100. For the main camera 500, an operator or a user is present. In this manner, with a configuration that does not require an operator or a user for some of the apparatuses, labor saving can be achieved.

Note that FIG. 1 is described with all of the signals being communicated via the communication network 700. However, video signals and control signals may be communicated via a different method, for example. For example, each of the plurality of cameras 300, 400, and 500 may directly supply the image capture control apparatus 100 with video signals via a cable. The cameras 300, 400, and 500 and the image capture control apparatus 100 include a communication circuit according to the video signal standard. The video signal standard may be but is not limited to the serial digital interface (SDI) standard, the high-definition multimedia interface (HDMI) (registered trademark), or the like, for example.

The image capture control apparatus 100 detects the subject from a video signal received from the overhead camera 300. The image capture control apparatus 100 determines whether or not to automatically control the image capture direction and the angle of view linked with the main camera 500 for each of the sub cameras 400a to 400c. Regarding each of the sub cameras 400 of which the image capture direction and the angle of view are to be automatically controlled linked with the main camera 500, the image capture control apparatus 100 determines the image capture direction and the angle of view on the basis of the set role, the subject detection result, and the state of the main camera 500. The image capture control apparatus 100 transmits a control command including the determined image capture direction and angle of view to the target sub camera 400. By setting the role for each of the sub cameras 400a to 400c, the determination method of the image capture direction and the angle of view of the sub cameras 400 can be individually set, and the flexibility in terms of operation control of the sub cameras 400a to 400c can be increased.

### Example of Functional Configuration of Each Apparatus

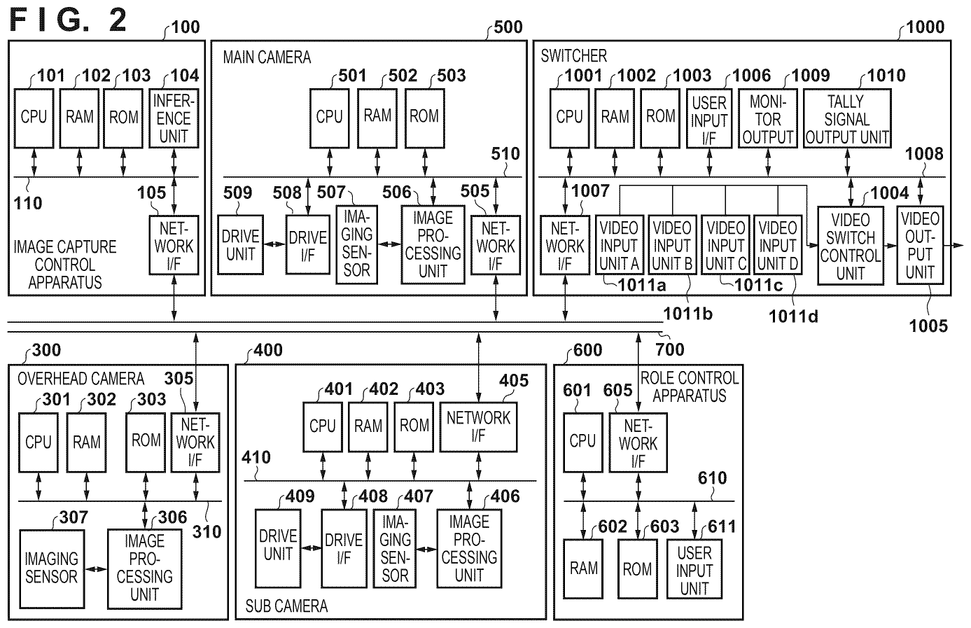

FIG. 2 is a block diagram illustrating an example of the functional configuration of each device forming the image capture system 10 illustrated in FIG. 1. However, the sub cameras 400a to 400c each have the same configuration, and thus in FIG. 2, only one sub camera 400 is illustrated. Note that the configurations implemented as functional blocks in the drawings may be implemented by integrated circuits such as an ASIC and FPGA, by discrete circuits, or by a combination including a memory and a processor that executes a program stored in the memory. Also, one functional block may be implemented by a plurality of integrated circuit packages or a plurality of functional blocks may be implemented by a single integrated circuit package. Also, the same functional block may have a different configuration depending on the operation environment, required capability, and the like.

### Image Capture Control Apparatus 100

First, an example of the functional configuration of the image capture control apparatus 100 will be described. The image capture control apparatus 100 may be a general purpose computer device such as a personal computer or a work station, for example. The image capture control apparatus 100 has a configuration in which a CPU 101, a RAM 102, a ROM 103, an inference unit 104, a network interface (I/F) 105, a user input unit 106, and a display unit 108 are connected to one another via an internal bus 110.

The CPU 101 is a microprocessor that can execute programmed commands. The functions of the image capture control apparatus 100 described below are implemented by the CPU 101 loading a program stored in the ROM 103 onto the RAM 102 and executing the program, for example. The functions of the image capture control apparatus 100 can be implemented by the CPU 101 executing an image capture control application running on the basic software (OS), for example.

The RAM 102 is used for loading programs to be executed by the CPU 101 and for temporarily storing data to be processed by the CPU 101, processing-in-progress data, and the like. Also, a portion of the RAM 102 may be used as video memory of the display unit 108.

The ROM 103 is rewritable non-volatile memory and stores programs (OS and applications) to be executed by the CPU 101, user data, and the like.

The inference unit 104 executes subject region detection processing using a machine learning model on video from the overhead camera 300. The inference unit 104, for example, is implemented using a hardware circuit that can execute machine learning model computations at high-speeds such as a graphics processing unit (GPU) and a neural network processing unit (NPU). Alternatively, the inference unit 104 may be implemented using a reconfigurable logic circuit such as a field-programmable gate array (FPGA). The CPU 101 may implement a function of the inference unit 104 by executing a program.

The machine learning model may be a convolutional neural network (CNN) trained according to the type of subject to be detected. Here, the inference unit 104 is configured to detect a human body region or a face region of a person from an input image as the subject region. Also, the inference unit 104 is configured to output the position and size of a rectangular region inscribing the subject region and the detection reliability for each detected subject region. Note that detection processing for different types of subject regions may be executed on the same input image using a plurality of types of machine learning models. Note that the inference unit 104 may execute subject region detection processing using a known method that does not use a machine learning model. The inference unit 104, for example, can detect a subject region using a method using local feature amounts such as SIFT and SURF, a method using pattern matching, or the like.

The network I/F 105 is an interface for connecting the image capture control apparatus 100 to the communication network 700. The image capture control apparatus 100 (CPU 101) can communicate with external apparatuses on the communication network 700 such as the overhead camera 300, the sub cameras 400, the main camera 500, the role control apparatus 600, the switcher 1000, and the like via the network I/F 105. Note that the image capture control apparatus 100 may communicate with external apparatuses via a different non-illustrated communication interface (USB, Bluetooth (registered trademark), or the like).

The CPU 101 communicates with each apparatus (the overhead camera 300, the sub cameras 400, the main camera 500, the role control apparatus 600, the switcher 1000) on the communication network 700. Thus, the CPU 101 obtains the network address of each apparatus at any timing and stores the network addresses in the RAM 102. Also, the CPU 101 obtains information (apparatus type, model name, and the like) of each apparatus at any timing (for example, at the time of the first communication) and stores the information in the RAM 102. In this manner, the CPU 101 knows at least the identification information and the apparatus type for the overhead camera 300, the sub cameras 400, the main camera 500, the role control apparatus 600, and the switcher 1000. Note that the user may provide any name to each of the apparatuses.

The user input unit 106 is an input device (not illustrated) such as a mouse, keyboard, touch panel, and the like. The image capture control apparatus 100 receives a user instruction via the user input unit 106.

The display unit 108 is a display apparatus such as a liquid crystal display (LCD) or the like. The display unit 108 displays a GUI screen provided by the OS, the image capture control application, and the like.

### Overhead Camera 300

Next, an example of the functional configuration of the overhead camera 300 will be described.

The CPU 301 is a microprocessor that can execute programmed commands. By loading a program stored in a ROM 303 onto a RAM 302 and executing the program, the CPU 301 controls the operation of each functional block and implements the function of the overhead camera 300 described below.

The RAM 302 is used for loading programs to be executed by the CPU 301 and for temporarily storing data to be processed by the CPU 301, processing-in-progress data, and the like. Also, the RAM 302 may be used as a buffer for video signals obtained during image capture.

The ROM 303 is a rewritable non-volatile memory. The ROM 303 stores programs executed by the CPU 301, setting values for the overhead camera 300, user data, and the like. Note that the ROM 303 can be used as a storage destination for video signals. The ROM 303 may include a built-in memory or a detachable memory card.

An imaging sensor 307 includes an imaging optical system and an image sensor. The image sensor, for example, may be a known CCD or CMOS color image sensor including a primary color Bayer array color filter. The image sensor includes a pixel array including a plurality of pixels in a two-dimensional array and a peripheral circuit for reading signals from the pixels. Each pixel accumulates a charge corresponding to the amount of incident light via photoelectric conversion. By reading a signal including voltage corresponding to the amount of charge accumulated in the exposure period from each pixel, the pixel signal group (analog image signal) representing the subject image formed on the imaging surface is obtained.

An image processing unit 306 applies a predetermined signal processing and image processing to an analog image signal output by the imaging sensor 307, generates a signal or image data according to the application, and obtains and/or generates various types of information.

The processing applied by the image processing unit 306 may include, for example, preprocessing, color interpolation processing, correction processing, detection processing, data modification processing, evaluation value calculation processing, special effects processing, and the like. The preprocessing may include A/D conversion, signal amplification, reference level adjustment, defective pixel correction, and the like. The color interpolation processing is processing for interpolating values of color components not included in the pieces of pixel data forming the image data that is executed in a case where a color filter is provided in the imaging sensor 307. Color interpolation processing may be referred to as demosaic processing. Correction processing may include various processing including white balance adjustment, gradation correction, correction (image restoration) of image degradation caused by an optical aberration in the imaging optical system, correction of the effects of vignetting of the imaging optical system, color correction, and the like. The data modification processing may include processing including trimming regions (trimming), combining, scaling, encoding and decoding, header information generation (data file generation), and the like. The data modification processing includes generating a video signal to be externally output and video data to be stored in the ROM 303. The evaluation value calculation processing may include processing including generating signals or evaluation values that are used in automatic focus detection (AF), generating evaluation values that are used in automatic exposure control (AE), and the like. AF and AE are performed by the CPU 301. Special effects processing may include processing including adding a blur effect, changing color tone, relighting, and the like. Note that these are examples of processing that can be applied by the image processing unit 306, and are not intended to limit the processing applied by the image processing unit 306. The image processing unit 306 outputs obtained or generated information and data to the CPU 301, the RAM 302, and the like according to the application.

Note that the type of processing and the settings applied by the image processing unit 306 can be controlled by transmitting a command from the image capture control apparatus 100 to the overhead camera 300.

A network I/F 305 is an interface for connecting the overhead camera 300 to the communication network 700. The overhead camera 300 (CPU 301) can communicate with an external apparatus on the communication network 700 such as the image capture control apparatus 100, the sub cameras 400, the main camera 500, and the role control apparatus 600 via the network I/F 305. Note that the overhead camera 300 may communicate with external apparatuses via a different non-illustrated communication interface (USB, Bluetooth, or the like).

### Sub Camera 400

Next, an example of the functional configuration of the sub camera 400 will be described. For the sub camera 400 and the overhead camera 300, functional blocks with the same name have the same function, and thus description will be omitted.

As described above, the sub camera 400 is a PTZ camera, and the image capture direction and angle of view can be controlled externally. Thus, the sub camera 400 includes a drive unit 409 that can perform a pan and tilt operation and a zoom operation and a drive I/F 408. The drive I/F 408 is a communication interface between the drive unit 409 and a CPU 401.

The drive unit 409 includes a pan/tilt mechanism that supports the sub camera 400 in a manner allowing for panning and tilting, a zoom mechanism that changes the angle of view of the imaging optical system, a motor that drives these mechanisms, and the like. The zoom mechanism may be used to enlarge or reduce the size of the image from an image processing unit 406. The drive unit 409 drives the motor according to an instruction received from the CPU 401 via the drive I/F 408 and adjusts the optical axis direction (image capture direction) of the imaging optical system and the angle of view.

### Main Camera 500

Next, an example of the functional configuration of the main camera 500 will be described. For the main camera 500 and the sub camera 400, functional blocks with the same name have the same function, and thus description will be omitted. The main camera 500 is user-operated. Here, a user remotely operates the main camera 500 by transmitting commands via the communication network 700. However, in a case where the main camera 500 is not a PTZ camera or the like, the user may directly operate the main camera 500.

The image capture control apparatus 100 (CPU 101) can obtain information of the image capture direction and the angle of view of the sub cameras 400 and the main camera 500 from the sub cameras 400 and the main camera 500 via a network I/F 505. Note that the image capture direction may be the pan and tilt angle of the drive unit 409 and a drive unit 509 with a predetermined reference direction set to 0°. The reference direction may be the direction directly facing the captured area.

Note that the sub cameras 400 and the main camera 500 include a light-emitting unit (a lamp, LED, or the like) for tally display. Tally display is a display indicating that the video being captured is currently being streamed or previewed. The tally display may indicate streaming in progress by a red light turning on and preview in progress by a green light turning on, but no such limitation is intended. The tally display can be performed by the CPU 401 or a CPU 501 of the camera on the basis of camera state information STREAMING supplied from the switcher 1000. In this manner, the camera state information STREAMING is used as a tally display control signal. This will be described below in detail.

### Role Control Apparatus 600

Next, an example of the functional configuration of the role control apparatus 600 will be described. A CPU 601 is a microprocessor that can execute programmed commands. By loading a program stored in a ROM 603 onto a RAM 602 and executing the program, the CPU 601 controls the operation of each functional block and implements the function of the role control apparatus 600.

The RAM 602 is used for loading programs to be executed by the CPU 601 and for temporarily storing data to be processed by the CPU 601, processing-in-progress data, and the like. Also, a portion of the RAM 602 may be used as video memory of a display unit 608.

The ROM 603 is a rewritable non-volatile memory and stores programs to be executed by the CPU 601, setting values for the role control apparatus 600, user data, and the like.

A user input unit 611 is an input device such as a button, a dial, a joystick, a touch panel, and the like. The role control apparatus 600 receives a user instruction relating to the settings for the roles of the sub cameras 400 via the user input unit 611.

A network I/F 605 is an interface for connecting the role control apparatus 600 to the communication network 700. The role control apparatus 600 (CPU 601) can communicate with external apparatuses on the communication network 700 such as the overhead camera 300, the sub cameras 400, the image capture control apparatus 100, and the like via the network I/F 605. Note that the role control apparatus 600 may communicate with external apparatuses via a different non-illustrated communication interface (USB, Bluetooth, or the like).

The display unit 608 is a display apparatus such as a liquid crystal display (LCD) or the like. The display unit 608 displays a GUI screen provided by the OS, a role setting application, and the like.

The role control apparatus 600 stores role setting information in the ROM 603, for example. The role setting information is information in which the identification information of the sub cameras 400 and information indicating the set roles are associated together. The CPU 601 displays a role setting screen on the display unit 608 by executing the role setting application. On the role setting screen, for example, identification information (network address, name set by user, and the like) of the sub cameras 400 and the currently set role names are displayed in association with one another. The initial value of the currently set role may be a preset default role. The current role displayed in association with the desired sub camera 400 can be changed by the user via operation of the user input unit 611.

When a user operation indicating to end setting operation, such as the operation of an OK button included on the role setting screen, is detected, the CPU 601 updates the role setting information stored in the ROM 603 according to the content of the role setting screen.

When the CPU 601 receives an obtain role command via the network I/F 605, the CPU 601 reads out the role setting information stored in the ROM 603 and transmits the role setting information to the obtain role command transmission source.

Note that in FIGS. 1 and 2, the role control apparatus 600 is described as an independent apparatus, but an image capture control application executed by the image capture control apparatus 100 may provide a function similar to that of the role control apparatus 600, for example. Also, the roles of the sub cameras 400 may be directly set, and the image capture control apparatus 100 may obtain the roles allocated to the sub cameras 400 from the sub cameras 400.

The roles that can be set to the sub cameras 400 are what predetermines how to use the information obtained from the main camera 500 in operation control of the sub camera 400. Here, as an example, the information of the main camera is used in the control of the subject tracking and zoom operation of the sub cameras 400.

### Switcher 1000

Next, an example of the functional configuration of the switcher 1000 will be described. The switcher 1000 includes a CPU 1001, a RAM 1002, video input units 1011, a video switch control unit 1004, a video output unit 1005, a user input I/F 1006, and a network I/F 1007. Also, 1008 denotes an internal bus that connects each of the blocks described above.

By loading a program stored in a ROM 1003 onto the RAM 1002 and executing the program, the CPU 1001 controls the operation of each functional block and implements the function of the switcher 1000.

The RAM 1002 is used for loading programs to be executed by the CPU 1001 and for temporarily storing data to be processed by the CPU 1001, processing-in-progress data, and the like. Also, a portion of the RAM 1002 may be used as the video memory of an external display apparatus connected to a monitor output unit 1009 or used as a buffer for input video signals.

The ROM 1003 is a rewritable non-volatile memory and stores programs to be executed by the CPU 1001, setting values for the switcher 1000, user data, and the like.

The video input units 1011a to 1011d are interfaces for receiving video from the sub cameras 400a to 400c and the main camera 500 and each may be constituted by a receiver compliant with a standard such as SDI, HDMI, or the like. In the present embodiment, the four video input units 1011a to 1011d are provided for receiving video from the sub cameras 400a to 400c and the main camera 500. However, it is sufficient that the number of video input units 1011 is two or more. Here, the video input unit 1011a receives video from the sub camera 400a, the video input unit 1011b receives video from the sub camera 400b, and the video input unit 1011c receives video from the sub camera 400c. Also, the video input unit 1011d receives video from the main camera 500.

The video from the sub cameras 400a to 400c and the main camera 500 may be input via the communication network 700 instead of being input to the video input units 1011a to 1011d. In a case where the video is input via the communication network 700, the video transmitted by the sub cameras 400 from a network I/F 405 and video transmitted by the main camera 500 via the network I/F 505 are received from the network I/F 1007. Note that video of the sub cameras 400a to 400c and the main camera 500 may be a combination of video input to the video input unit 1011 and video input from the network I/F 1007. Note that five or more videos may be input via the communication network 700.

The video switch control unit 1004 outputs, to the video output unit 1005 described below, one of the plurality of videos input from the sub cameras 400a to 400c and the main camera 500 to the video input units 1011a to 1011d. The video switch control unit 1004 outputs the video selected via the user input I/F 1006 described below. The video output by the video switch control unit 1004 is used in broadcasting, streaming, recording, and the like and is referred to as streaming video for convenience in the present specification, but may also be referred to as the main video. Note that the video switch control unit 1004 is configured to select and output one from among all of the videos input to the switcher 1000 regardless of the input path.

The video output unit 1005 is an interface for outputting video output by the video switch control unit 1004 to a non-illustrated live streaming device, program recording apparatus, or the like and is constituted of a transmitter compliant with SDI, HDMI, or a similar standard.

The monitor output unit 1009 generates a video displaying a list of a plurality of videos input to the switcher 1000 via the video input units 1011a to 1011d or the communication network 700. Also, the monitor output unit 1009 outputs the generated video to a non-illustrated external display apparatus. The monitor output unit 1009 also outputs the data of the settings screen of the switcher 1000 to an external display apparatus.

The user input I/F 1006 is an interface for connecting to a button, a dial, a joystick, a touch panel, or a similar input device (not illustrated), for example. The switcher 1000 receives a user instruction relating to the selection of a streaming video and a preview video or the settings of the switcher 1000 via the user input I/F 1006. The preview video is a video scheduled to be the next streaming video.

The CPU 1001 allocates information (state information) to each camera inputting video that can be selected by the video switch control unit 1004 indicating whether the video being captured is streaming video, preview video, or otherwise. Specifically, the CPU 1001 determines the state information of the camera capturing video (streaming video) being output from the video output unit 1005 as “streaming in progress”. Also, the CPU 1001 determines the state information of the camera capturing preview video as “preview in progress”. Furthermore, the CPU 1001 determines the state information of the cameras capturing remaining videos as “standby”. The CPU 1001 associates the state information with the identification information of each camera and stores this as camera state information STREAMING in the RAM 1002. The identification information of the sub cameras 400 may be any information that can identify each sub camera such as a unique name attached by the user, a serial number, a network address, and the like. The CPU 1001 updates the camera state information STREAMING stored in the RAM 1002 each time the video signal selection is updated, for example.

A tally signal output unit 1010 transmits a control signal (tally information) for the camera with the state information of “streaming in progress” and “preview in progress” to perform a tally display via the network I/F 1007. Accordingly, the tally information may be used as the camera state information STREAMING.

The network I/F 1007 is an interface for connecting the switcher 1000 to the communication network 700. The switcher 1000 (CPU 1001) can communicate with an external apparatus on the communication network 700 such as the overhead camera 300, the sub cameras 400a to 400c, the main camera 500, and the image capture control apparatus 100 via the network I/F 1007. Note that the switcher 1000 may communicate with external apparatuses via a different non-illustrated communication interface (USB, Bluetooth, or the like).

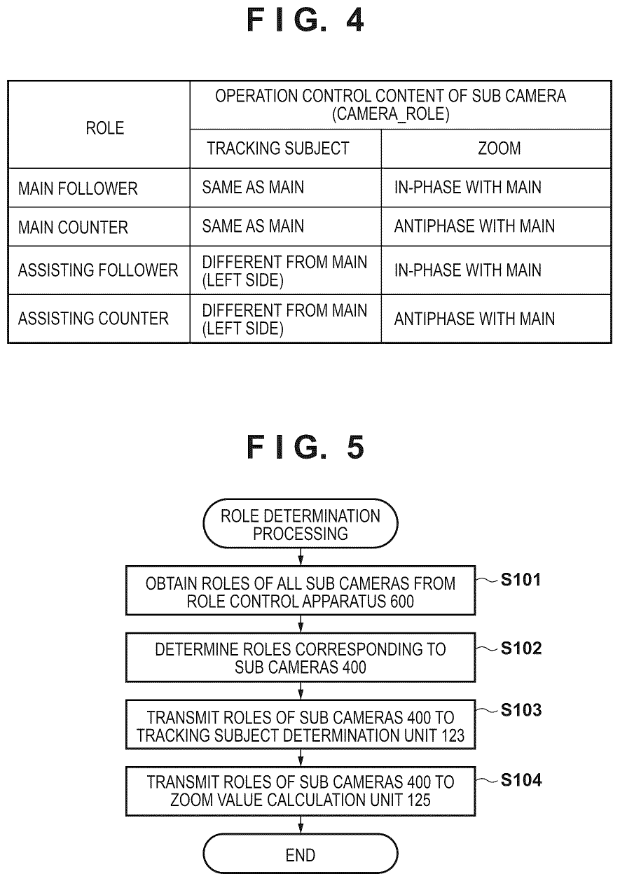

FIG. 4 illustrates an example of types of roles that can be set for the sub cameras 400 and control content associated with the roles. The control content of each role can be stored in the ROM 603 of the role control apparatus 600 and the ROM 103 of the image capture control apparatus 100 in the table format illustrated in FIG. 4, for example. Here, one of “main follower”, “main counter”, “assisting follower”, and “assisting counter” can be set as role ROLE. In the case of a plurality of the sub cameras 400, the role can be set per sub camera.

Regarding the sub cameras 400 with the role ROLE of “main follower”, the image capture control apparatus 100 (CPU 101) sets the tracking subject to match the main camera 500, and when a zoom operation is performed for the main camera 500, in-phase zoom control of the sub cameras 400 is also performed. Here, in-phase indicates that the zoom direction (telephoto direction or wide-angle direction) is the same, that is, that the direction of the change in the angle of view is the same. Antiphase-phase indicates that the zoom direction (telephoto direction or wide-angle direction) is the opposite direction, that is, that the direction of the change in the angle of view is the opposite direction. Note that if the zoom direction is in-phase, the angle of view does not need to be the same as that of the main camera 500, and in the case of in-phase and antiphase, the degree of change in the zoom (change speed, rate of change, or the like) does not need to be the same as that of the main camera 500.

Regarding the sub cameras 400 with the role ROLE of “main counter”, the image capture control apparatus 100 (CPU 101) sets the tracking subject to match the main camera 500, and when a zoom operation is performed for the main camera 500, inverted-phase zoom control of the sub cameras 400 is performed. Accordingly, in a case where a zoom-up operation is performed for the main camera 500, the image capture control apparatus 100 (CPU 101) performs control to zoom-down the sub cameras 400 with that role. Note that zoom-up indicates the zoom being changed to the telephoto direction (telephoto end direction), and zoom-down indicates the zoom being changed to the wide-angle direction (wide end direction). In a case where zoom control is performed by the image processing unit 406, zoom-up indicates reducing a region cropped from an image and increasing the magnification ratio of the cropped region more than pre-region-change. Zoom-down indicates enlarging a region cropped from an image and decreasing the magnification ratio of the cropped region more than pre-region-change.

Regarding the sub cameras 400 with the role ROLE of “assisting follower”, the image capture control apparatus 100 (CPU 101) sets the tracking subject to one different from that of the main camera 500, and when a zoom operation is performed for the main camera 500, in-phase zoom control of the sub cameras 400 is also performed.

Regarding the sub cameras 400 with the role ROLE of “assisting counter”, the image capture control apparatus 100 (CPU 101) sets the tracking subject to one different from that of the main camera 500. Also, when a zoom operation is performed for the main camera 500, antiphase zoom control of the sub cameras 400 is performed by the image capture control apparatus 100.

Here, the sub cameras 400 with the role ROLE of “assisting follower” and “assisting counter” are set, from among subjects other than the main subject of the main camera 500 in an image, with a subject on the left side as the tracking subject of the sub cameras 400. Note that the tracking subject of the sub cameras 400 may be set according to a different condition. For example, from among subjects other than the main subject of the main camera 500, a subject on the right side, upper side, or lower side may be set as the tracking subject of the sub camera. Alternatively, from among subjects other than the main subject of the main camera 500, a subject furthest forward or backward may be set as the tracking subject of the sub camera 400.

Also, only one of tracking subject setting and zoom control may be performed, and another control item may be added.

In the role setting information stored in the ROM 603 by the role control apparatus 600, information (name of type described above, number allocated to the type, and the like) indicating the role ROLE is associated with the identification information of the sub cameras 400. The CPU 101 of the image capture control apparatus 100 obtains the role setting information from the role control apparatus 600 and performs operation control of the sub cameras 400 according to the type of the role ROLE set for the sub cameras 400.

Note that in the case of a change to the setting of a role for the sub camera 400, the role control apparatus 600 may notify an external apparatus (for example, the image capture control apparatus 100). Accordingly, the role setting change can be immediately applied to the operation control of the sub camera 400.

### Description of Operations of Each Apparatus

Next, the operations of each apparatus in the multi-camera image capture system will be described. Here, the image capture control apparatus 100 automatically controls the image capture operations of the sub cameras 400 on the basis of video from the overhead camera 300, information obtained from the main camera 500, the camera state information STREAMING, and roles set for the sub cameras 400.

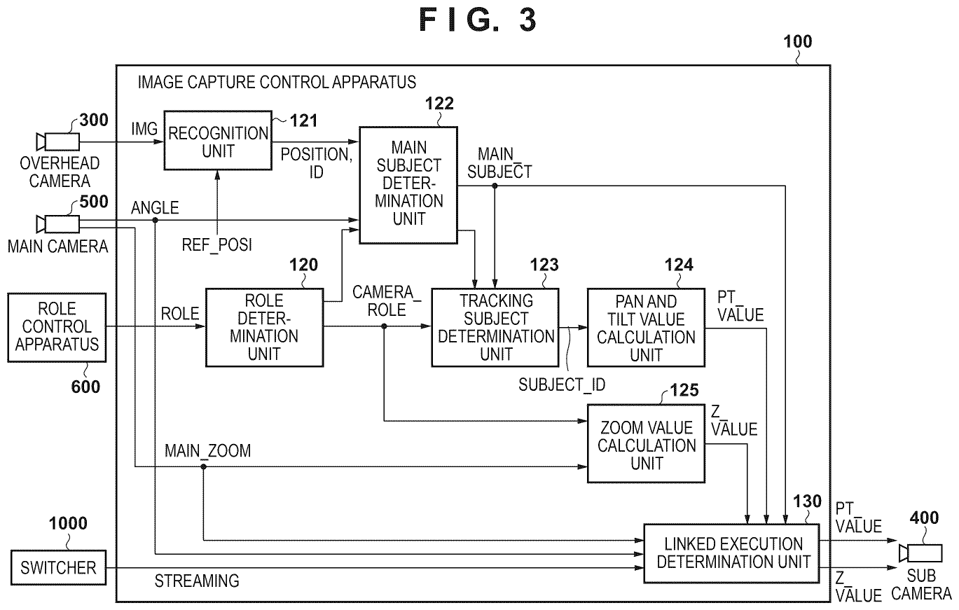

FIG. 3 is a diagram illustrating a sequence of processing executed when the image capture control apparatus 100 controls the operations of the sub cameras 400 focusing on the main operations and signal flow. The main operations of the functional blocks illustrated in the image capture control apparatus 100 are schematically illustrated and correspond to the main functions provided by the image capture control application. Each functional block in FIG. 3 is implemented by a combination of the CPU 101 executing the image capture control application and one or more functional blocks of the image capture control apparatus 100 illustrated in FIG. 2.

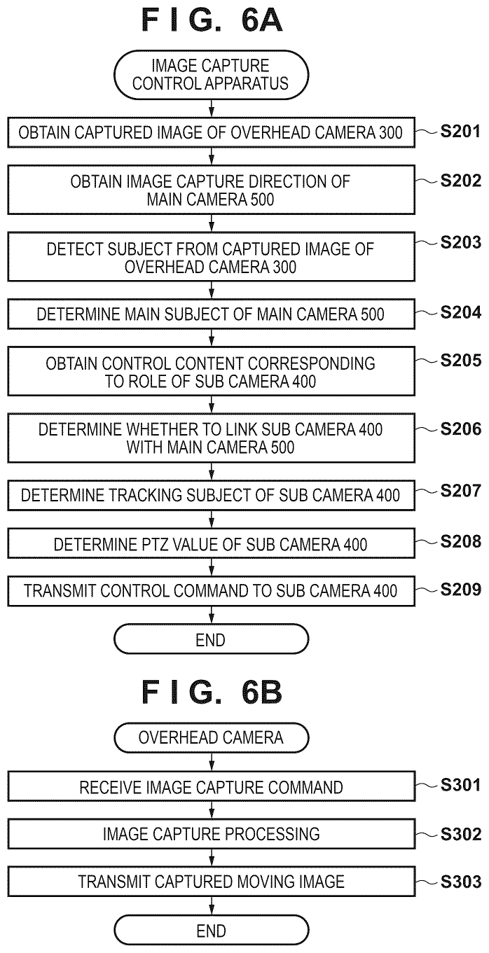

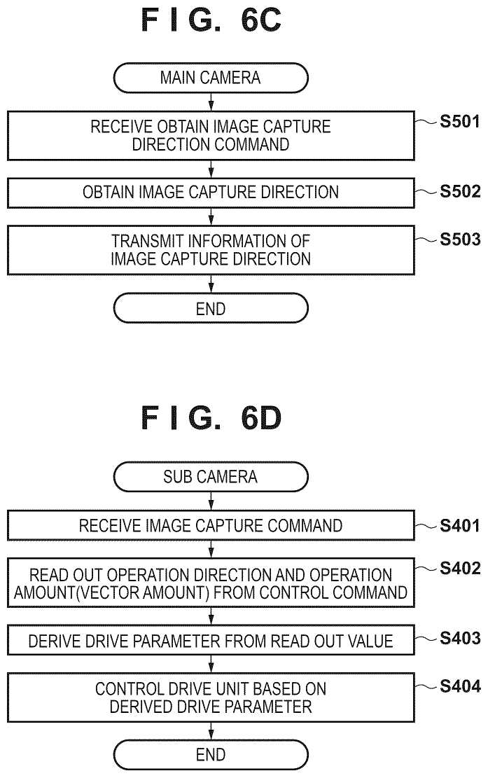

FIG. 5 is a flowchart illustrating the operations of the CPU 101 as a role determination unit 120. Also, FIGS. 6A to 6D are flowcharts relating to the operations of the image capture control apparatus 100, the overhead camera 300, the main camera 500, and the sub cameras 400.

In the following description, the three-dimensional coordinate values of the viewpoint position of the overhead camera 300 and the image capture direction (optical axis direction) are known by the image capture control apparatus 100. Also, the known position information such as the three-dimensional coordinate values of the viewpoint position of the sub cameras 400 and the main camera 500, the coordinate values of a mark disposed in the captured area, and the like is stored in advance in the ROM 103 as predetermined position information REF_POSI. Note that the position coordinate system is predetermined by the type of the position.

### Operations of Role Determination Unit 120

First, operations of the CPU 101 as the role determination unit 120 illustrated in FIG. 3 will be described with reference to the flowchart of FIG. 5. The operations described below are implemented by the CPU 101 executing the image capture control application.

Note that the start timing of the operations illustrated in the flowchart of FIG. 5 is not particularly limited, but is at least before the start of the control of image capture operations of the sub cameras 400. Also, the operations described below are executed also in a case where a notification indicating the change of a role setting for the sub cameras 400 is received from the network I/F 105 via the communication network 700 from the role control apparatus 600.

In S101, the CPU 101, as the role determination unit 120, obtains the role ROLE (role setting information) corresponding to the sub cameras 400 from the role control apparatus 600. The CPU 101, as the role determination unit 120, obtains the role setting information described above from the role control apparatus 600 by transmitting an obtain role command from the network I/F 105 to the role control apparatus 600 via the communication network 700, for example. The CPU 101 stores the obtained role setting information in the RAM 102.

In S102, the CPU 101, as the role determination unit 120, references the role setting information stored in the RAM 102 on the basis of the identification information of the sub cameras 400 and determines an operation control content CAMERA_ROLE for the sub cameras 400. In S103, the CPU 101, as the role determination unit 120, transmits the obtained operation control content CAMERA_ROLE to a tracking subject determination unit 123. In practice, the CPU 101 stores the operation control content CAMERA_ROLE in a specific area of the RAM 102 and references this when functioning as the tracking subject determination unit 123.

In S104, the CPU 101, as the role determination unit 120, transmits the obtained operation control content CAMERA_ROLE to a zoom value calculation unit 125. In practice, the CPU 101 stores the operation control content CAMERA_ROLE in a specific area of the RAM 102 and references this when functioning as the zoom value calculation unit 125.

### Operations of Image Capture Control Apparatus 100

Next, operations of the image capture control apparatus 100 controlling image capture by the sub cameras 400 will be described with reference to FIGS. 3 and 6A. The operations described below correspond to the operations of the CPU 101 functioning as a recognition unit 121, a main subject determination unit 122, the tracking subject determination unit 123, a pan and tilt value calculation unit 124, and the zoom value calculation unit 125 of FIG. 3. The operations described below are implemented by the CPU 101 executing the image capture control application.

In S201, the CPU 101 transmits an image capture instruction command using a predetermined protocol from the network I/F 105 to the overhead camera 300 via the communication network 700. As a response to this command, supply of a video signal (moving image data) IMG begins from the overhead camera 300 to the network I/F 105 via the communication network 700. After the start of storage of the video signal IMG received by the network I/F 105 to the RAM 102, the CPU 101 executes S202.

In S202, the CPU 101 obtains information ANGLE indicating the image capture direction from the main camera 500. Specifically, the CPU 101 transmits an obtain image capture direction command using a predetermined protocol from the network I/F 105 to the main camera 500 via the communication network 700. The CPU 501 of the main camera 500, as a response to the obtain image capture direction command, transmits the information ANGLE indicating the current image capture direction of the main camera 500 to the image capture control apparatus 100. The information ANGLE may be the pan and tilt angle of the drive unit 509, for example. The CPU 101 stores the obtained information ANGLE in the RAM 102.

In S203, the recognition unit 121 executes the following processing.

(1) Subject region detection processing is applied to the input frame image, and the detection result is stored.

(2) Subject position information (image coordinates) is coordinate-converted for each detected subject region.

(3) Identification processing is applied per detected subject region, and identification information is identified (information for identification processing is added in the case of a new subject).

(4) Identification information ID[n] and position information POSITION[n] are associated together and stored per detected subject region.

The recognition unit 121 is implemented mainly by the CPU 101 and the inference unit 104. The CPU 101 reads out, from the RAM 102, one frame of the video received from the overhead camera 300 and inputs it into the inference unit 104.

The operations of the recognition unit 121 will be described below in order.

(1) First, the inference unit 104 inputs a frame image into a machine learning model and detects a subject region. The inference unit 104 stores the position and size per detected subject region output by the machine learning model as the detection result and the detection reliability in the RAM 102. The position and the size of the subject region may be any information that can identify the position and size of a rectangular region inscribing the subject region. Here, the central coordinates of the lower side of the rectangular region, the width, and the height are used as the position and size of the subject region.

Also, the inference unit 104 stores the detection result for the first frame image in the RAM 102 in association with the identification information ID[n] of the subject. Here, n is the number of the subject and is an integer taking a value from 1 to the total number of subject regions. Also, the inference unit 104 stores the subject region detected from the first frame image in the RAM 102 as a template for identifying each of the subjects in association with the identification information ID[n] of the subject. In a case where template matching is not used in identifying the subject, a template may not be stored.

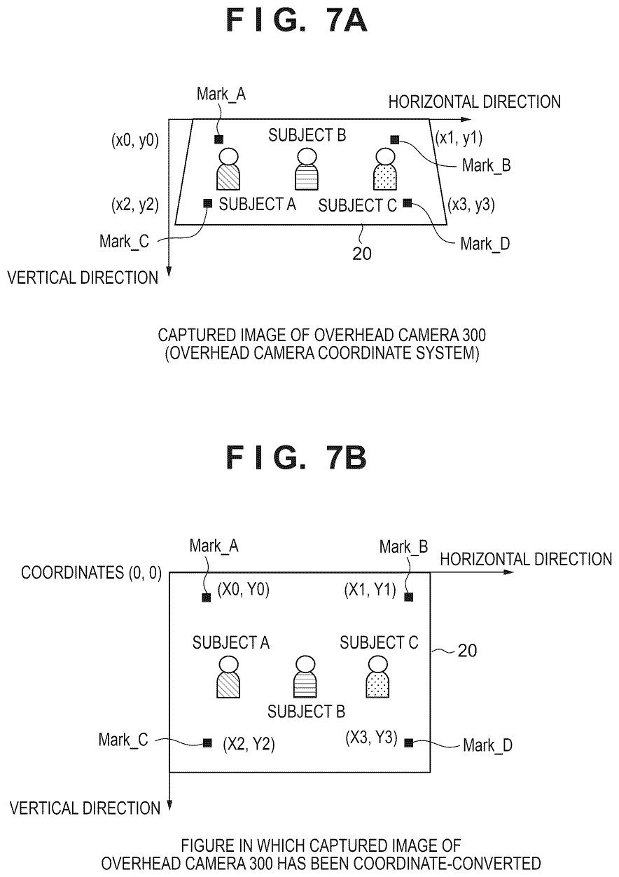

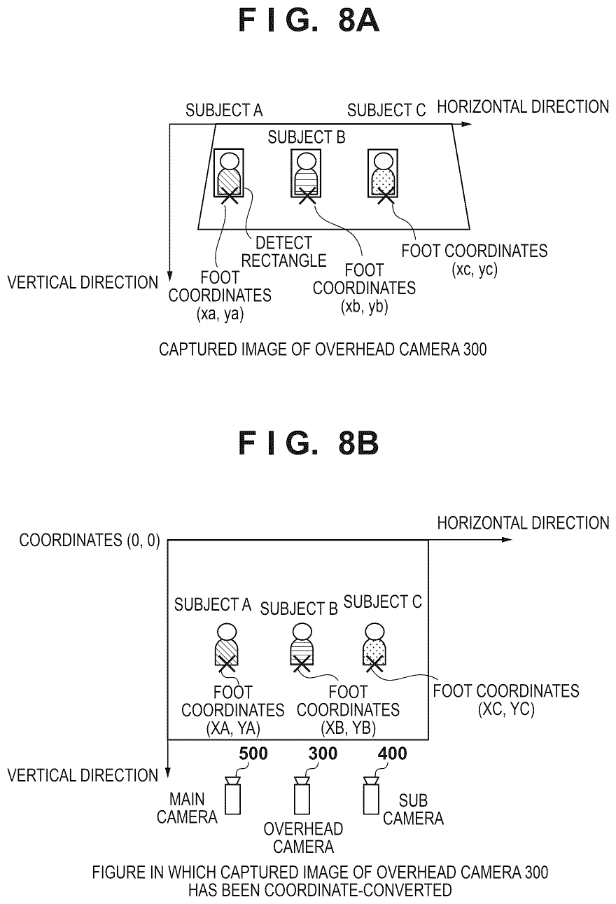

FIG. 8A illustrates an example of the result of subject detection processing by the inference unit 104 on the video of the overhead camera 300 illustrated in FIG. 7A. Here, a region of human subjects A to C in a captured area 20 is detected, and the central coordinates (foot coordinates) of the lower side of the rectangular region inscribing the subject region is output as the position.

Note that for coordinate conversion described below, in a case where a mark is disposed at a known position in the captured area 20 as illustrated in FIG. 7B for example, the CPU 101 detects an image of the mark included in the frame image (FIG. 7A) and stores the position in the RAM 102. The mark image detection may be configured to be executed by the inference unit 104. The mark image detection can be performed via any known method such as pattern matching using a mark template. A mark image may be detected using a prestored machine learning model for mark detection.

(2) Next, the coordinate conversion executed by the inference unit 104 will be described. FIG. 7A schematically illustrates a video of the overhead camera 300, and FIG. 7B schematically illustrates the captured area 20 as seen from directly above the center. The inference unit 104 performs coordinate conversion of the position of the subject region in the coordinate system of the overhead camera to a value of a coordinate system (planar coordinate system) when the captured area 20 is seen from directly above.

Here, the coordinate conversion to a value of a planar coordinate system is convenient for calculating the pan value (movement angle in a horizontal plane) for image capture of a specific subject by the sub cameras 400. Note that here it is assumed that the sub cameras 400 are installed so that the drive unit 409 performs pan operation in the horizontal plane parallel with the floor of the captured area 20.

The coordinate conversion can be performed via various methods, but here, marks are disposed at a plurality of known positions on the floor of the captured area 20 and coordinate conversion is performed from the overhead camera coordinate system to a planar coordinate system on the basis of the mark positions in the video obtained by the overhead camera 300. Note that coordinate conversion may be performed using the viewpoint position and the image capture direction of the overhead camera 300 or the like instead of using the marks.

The coordinate conversion can be performed using a homography conversion matrix H according to the following Formula 1.

$$( \begin{matrix}X \\ Y \\ W\end{matrix} ) = H ( \begin{matrix}x \\ y \\ 1\end{matrix} ) \qquad Formula 1$$

In Formula 1, x, y on the right side are the horizontal coordinates and the vertical coordinates in the overhead camera coordinate system, and X, Y on the left side are the horizontal coordinates and vertical coordinates of the planar coordinate system.

The homography conversion matrix can be calculated by substituting the coordinates of four marks detected from the video and the (known) coordinates of four marks disposed in the captured area 20 into Formula 1 and solving simultaneous equations. In a case where the positional relationship between the captured area 20 and the overhead camera 300 is fixed, the homography conversion matrix H can be calculated in advance at the time of an image capture test and stored in the ROM 103, for example.

The CPU 101 reads out the position of the subject region from the RAM 102 and performs coordinate conversion to a value of a planar coordinate system. FIG. 8B schematically illustrates a state in which foot coordinates (x, y) of each subject region detected in the video of the overhead camera 300 in FIG. 8A has been coordinate-converted to coordinates (X, Y) of the planar coordinate system using Formula 1 and the homography conversion matrix H stored in the ROM 103. The CPU 101 stores the coordinate-converted foot coordinates in the RAM 102 as POSITION[n].

(3) Next, the operation of the inference unit 104 identifying the identification information ID[n] of the subject will be described. Here, a subject is identified using template matching. Identification of a subject is performed on a processing result of subject detection from the second time onward. For the first processing result, the identification information ID[n] is newly allocated to the subject region.

The inference unit 104 identifies the identification information ID[n] of the detected subject region via template matching using a template stored in the RAM 102. Accordingly, the subject in the captured area is identified. For example, the inference unit 104 calculates an evaluation value indicating the correlation with the template for each detected subject region. Also, the inference unit 104 identifies the identification information ID[n] corresponding to a template with certain correlation or higher and with the highest correlation as the identification information ID[n] of the subject region. For the evaluation value, a known value can be used such as the sum of absolute differences of the pixel values, for example.

Note that for a subject region without a correlation equal to or greater than a certain level with respect to all of the templates, the inference unit 104 allocates it a new identification information ID[n] and adds the subject region image to the templates.

Also, the inference unit 104 may use the subject region detected in the most recent frame image to update a known template or delete a template that has not had a subject region with a certain correlation or higher for a certain period of time. Also, the inference unit 104 may store a template corresponding to identification information ID[n] that frequently appears in the ROM 103.

Note that the subject may be identified via a method other than template matching. For example, the subject region may be identified as the same identification information ID[n] as the subject region that is closest in terms of the most recent detection position and/or size. Also, the position in the current frame image may be predicted via a Kalman filter or the like from a change in position in a plurality of previous detection results associated with the same identification information, and the subject region that is closest to the predicted position may be identified with the same identification information ID. Also, a combination of these methods may be used. By not using template matching, the identification accuracy for different subjects that look similar can be increased.

(4) The inference unit 104 associates together the identified identification information ID[n] and the position (planar coordinate system) POSITION[n] of the corresponding subject region and stores them in the RAM 102.

Note that of the processing (1) to (4), processing other than subject detection may be executed by the CPU 101 instead of the inference unit 104.

Here, the video of the overhead camera 300 is used to obtain the identification information ID[n] and position POSITION[n] relating to the subject in the captured area 20. However, the video of the sub cameras 400 may be used. In the case of a plurality of the sub cameras 400, the CPU 101 executes the operations illustrated in the flowchart of FIG. 6A for each sub camera 400. The position of the subject region is output as a value in a coordinate system per sub camera 400. Accordingly, the overhead camera 300 is not required, but using the overhead camera 300 is thought to give better subject detection accuracy.

Returning to the description of FIG. 6A, in S204, the CPU 101, as the main subject determination unit 122 of FIG. 3, determines the main subject as the tracking subject of the main camera 500. The CPU 101 can determine, from among the subjects detected in S203, the main subject of the main camera 500 on the basis of the image capture direction of the main camera 500 obtained in S202. The CPU 101 stores the identification information ID[n] corresponding to the subject region determined as the main subject of the main camera 500 in the RAM 102 as identification information MAIN_SUBJECT of the main subject.

For example, the CPU 101 can determine the subject closest to the image capture direction of the main camera 500 in the planar coordinate system as the main subject of the main camera 500. Note that in a case where there are a plurality of subjects with a distance to the image capture direction of the main camera 500 that is equal to or less than a threshold, the user may select the main subject from among these.

In a case where the user selected the main subject, the CPU 101 displays the frame image obtained by applying the subject detection processing in S202 on the display unit 108 or an external display apparatus together with an indicator indicating the image capture direction and an indicator indicating the subject region corresponding to the main subject candidate. The subject region indicator may be a rectangular frame indicating the outer edge of the subject region as illustrated in FIG. 8A, but a different indicator may be used. Also, the CPU 101 may display a message or the like prompting the user to select a main subject in an image on the display unit 108.

The user can operate the user input unit 106 (input device) and select the subject region corresponding to the desired main subject. The selection method is not particularly limited, and a mouse and keyboard may be operated to designate a desired subject region.

When a user operation to designate a subject region is detected, the CPU 101 stores the identification information ID[n] corresponding to the designated subject region in the RAM 102 as the identification information MAIN_SUBJECT of the main subject.

Next, in S205, the CPU 101, as the tracking subject determination unit 123 of FIG. 3, obtains the operation control content CAMERA_ROLE corresponding to the role set for the sub cameras 400. Specifically, the CPU 101 reads out the operation control content CAMERA_ROLE obtained via the role determination processing described using FIG. 5 and stored in the RAM 102. Note that in the case of a plurality of the sub cameras 400, the CPU 101 executes the processing of S205 to S209 for each sub camera.

In S206, the CPU 101, as a linked operation determination unit 130, determines whether or not to link the sub cameras 400 with the main camera 500. The determination method will be described below in detail. Also, a linked operation flag is stored in the RAM 102 as a flag for switching between being linked and not. The linked operation flag takes a value for on and off and is on by default. In S206, in a case where it is determined to link the sub cameras 400 with the main camera 500, the CPU 101 leaves the linked operation flag of the sub cameras 400 stored in the RAM 102 unchanged as on. However, in a case where it is determined not to link, the CPU 101 updates the linked operation flag of the sub cameras 400 stored in the RAM 102 to off.

In S207, the CPU 101, as the tracking subject determination unit 123, determines the subject to be tracked for image capture by the sub cameras 400. In a case where the linked operation flag is off, the CPU 101 does not change the tracking subject of the sub cameras 400 even if the main subject of the main camera 500 changes.

On the other hand, if the linked operation flag is on, the CPU 101 determines the subject to be tracked for image capture by the sub cameras 400 according to the main subject of the main camera 500 in accordance with the operation control content CAMERA_ROLE. The CPU 101 determines the tracking subject of the sub cameras 400 in accordance with the defined tracking subject (FIG. 4) included in the operation control content CAMERA_ROLE.

In a case where the tracking subject of the sub cameras 400 is to be the same as the main subject of the main camera 500, the CPU 101 sets the identification information MAIN_SUBJECT of the main subject determined in S203 as identification information SUBJECT_ID of the tracking subject of the sub cameras 400.

In a case where the tracking subject of the sub cameras 400 is to be a subject located on the left side from among subjects other than the main subject of the main camera 500, the CPU 101 detects a subject region located at the left end of a subject region other than that of the main subject from among the subject regions detected in S203. Also, the CPU 101 sets the identification information ID[n] corresponding to the detected subject region as the identification information SUBJECT_ID of the tracking subject of the sub cameras 400.

The CPU 101 writes the identification information SUBJECT_ID of the determined tracking subject to the RAM 102. In a case where the tracking subjects may be different depending on the sub camera, the CPU 101 associates the identification information SUBJECT_ID of the tracking subject with the identification information of the sub camera and stores these. Note that in a case where the tracking subject is changed, the CPU 101 stores the information of the previous tracking subject without deletion in the RAM 102.

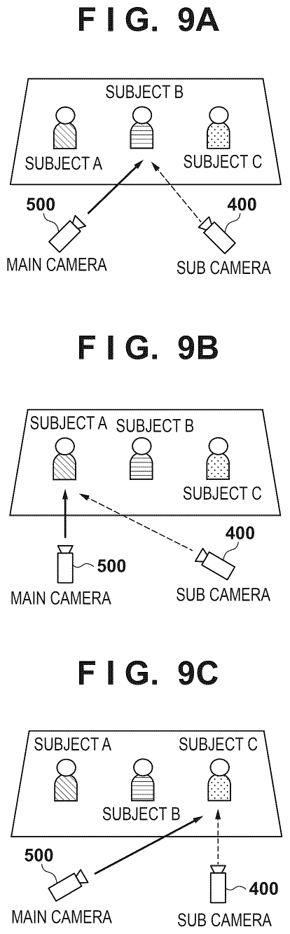

Here, operations in a case where the role set for the sub camera 400 is “main follower” will be described using FIGS. 9A to 9C. The image capture control apparatus 100 performs control so that the main subject of the main camera 500 is tracked by the sub camera 400 set with the role of “main follower”.

Accordingly, in a case where the main subject of the main camera 500 is determined to be subject B as illustrated in FIG. 9A, the CPU 101 sets the subject B as the tracking subject of the sub camera 400. Thereafter, in a case where the main subject of the main camera 500 is determined to have changed to subject A as illustrated in FIG. 9B, the CPU 101 changes the tracking subject of the sub camera 400 to the subject A. In a similar manner, in a case where the main subject of the main camera 500 is determined to have changed to subject C as illustrated in FIG. 9C, the CPU 101 changes the tracking subject of the sub camera 400 to the subject C.

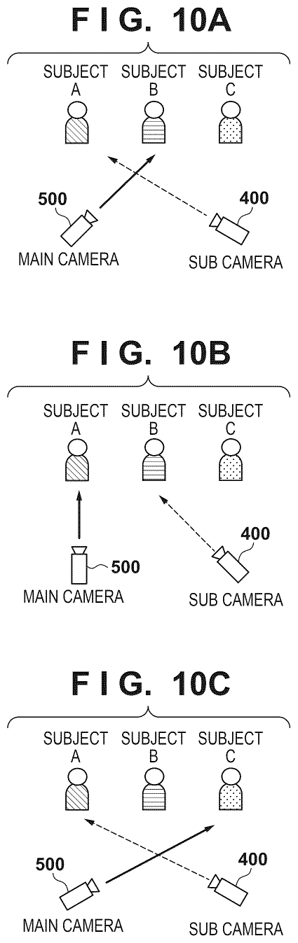

Operations in a case where the role set for the sub camera 400 is “assisting follower” will be described using FIGS. 10A to 10C. The image capture control apparatus 100 performs control so that, from among subjects other than the main subject of the main camera 500, a subject located on the left side is tracked by the sub camera 400 set with the role of “assisting follower”.

Accordingly, in a case where the main subject of the main camera 500 is determined to be subject B as illustrated in FIG. 10A, the CPU 101 sets, from among the subjects A and C, the subject A on the left side as the tracking subject of the sub camera 400. Thereafter, in a case where the main subject of the main camera 500 is determined to have changed to subject A as illustrated in FIG. 10B, the CPU 101 changes the tracking subject of the sub camera 400 to, from among the subjects B and C, the subject B on the left side. Also, in a case where the main subject of the main camera 500 is determined to have changed to subject C as illustrated in FIG. 10C, the CPU 101 changes the tracking subject of the sub camera 400 to, from among the subjects A and B, the subject A on the left side.

By dynamically changing the roles set to the sub cameras 400 via the role control apparatus 600, the tracking subject of the sub cameras 400 can be changed and flexible automatic image capture can be achieved.

Returning to FIG. 6A, in S208, the CPU 101, as the pan and tilt value calculation unit 124, calculates the amount of change required for the pan angle and the tilt angle for the sub camera 400 to track the tracking subject determined in S207 for image capture. Also, the CPU 101, as the zoom value calculation unit 125, calculates the zoom value of the sub camera 400 in accordance with the change in the angle of view of the main camera 500. In the example described below, one sub camera 400 is provided. However, in the case of a plurality of the sub cameras 400, calculation of the amount of change in the pan angle and the tilt angle and calculation of the zoom value is performed for each sub camera.

First, the operations of the CPU 101 as the pan and tilt value calculation unit 124 will be described. Here, the following information is stored in advance in the ROM 103 as the predetermined position information REF_POSI for each sub camera 400.
Three-dimensional coordinates of installation position (values in a planar coordinate system)
Image capture direction corresponding to initial value for pan angle and tilt angle of drive unit
Controllable range for pan and tilt angle
   The CPU 101 reads out position information POSITION_OH corresponding to the identification information SUBJECT_ID of the tracking subject of the sub camera 400 from the RAM 102. The CPU 101 first determines the pan angle from the position information POSITION_OH and the installation position of the sub camera 400.

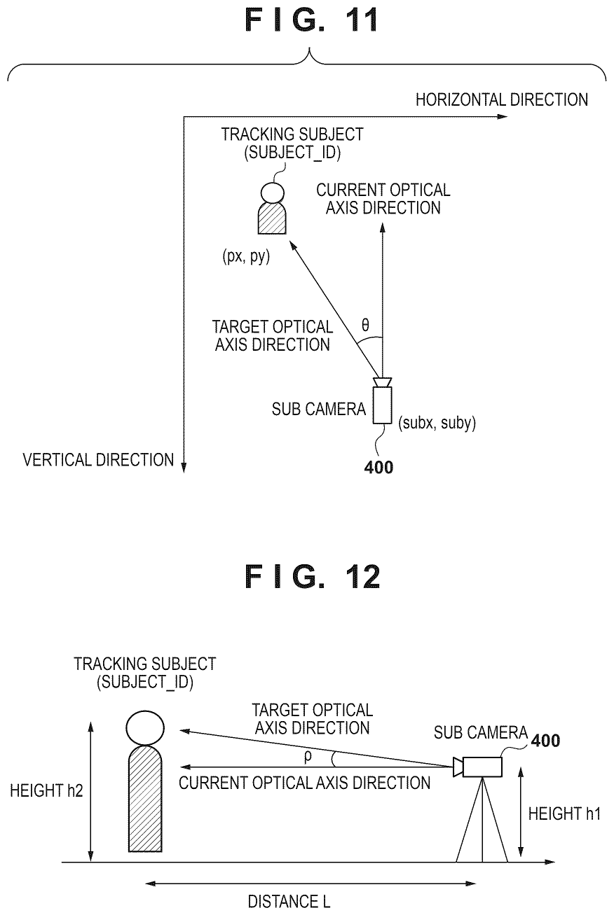

FIG. 11 illustrates an example of the positional relationship between the sub camera 400 and the tracking subject in a planar coordinate system. Here, a pan angle θ for directing the optical axis direction of the sub camera 400 to the subject position is determined. The CPU 101 calculates the pan angle θ using the following Formula 2.

$$θ = {tan}^{- 1} \frac{px - subx}{py - suby} ( rad ) \qquad Formula 2$$

px, py in Formula 2 are the horizontal coordinates and the vertical coordinates of the position information POSITION_OH corresponding to the identification information SUBJECT_ID of the tracking subject. Also, subx, suby are the horizontal coordinates and the vertical coordinates of the installation position of the sub camera. Here, the current pan angle is the initial value 0°, and the optical axis direction is the vertical direction (Y-axis direction). In a case where the current optical axis direction is not the vertical direction, the difference in angle between the current optical axis direction and the vertical direction may be reflected on the angle obtained via Formula 2. Also, the pan direction is the anticlockwise direction if subx>px and is the clockwise direction if subx<px.

Next, the tilt angle determination method will be described using FIG. 12. FIG. 12 illustrates a sub camera and a tracking subject as seen from the side. The current optical axis of the sub camera 400 is the horizontal direction, the height of the sub camera 400 is h1, and the height of the face of the tracking subject the optical axis is directed at is h2. The difference in angle (tilt angle) in the height direction between the current optical axis direction and the target optical axis direction is p. The CPU 101 calculates the tilt angle ρ using the following Formula 3 and Formula 4.

$$L = \sqrt{{( px - subx )}^{2} + {( py - suby )}^{2}} \qquad Formula 3$$

$$ρ = {tan}^{- 1} \frac{h 2 - h 1}{∠} ( rad ) \qquad Formula 4$$

The coordinate values used in Formula 4 are the same as the coordinate values used in Formula 2. The h1 and h2 are input into the image capture control application in advance and stored in the RAM 102. In this case, the identification number associated with the h2 per subject and the identification number allocated in the subject detection processing are made to be the same. Alternatively, a value measured in real time using a sensor (not illustrated) may be used as the h2.

Here, the current tilt angle is the initial value 0°, and the optical axis direction is the horizontal direction (constant height). In a case where the current optical axis direction is not the horizontal direction, a difference in angle between the current optical axis direction and the horizontal direction may be reflected on the angle obtained via Formula 4. Also, the tilt direction is a downward direction if h1>h2 and is an upward direction if h1<h2.

The CPU 101 periodically communicates with the sub camera 400 via the communication network 700 and obtains and stores the current optical axis direction (pan angle and tilt angle of the drive unit) in the RAM 102. Note that the communication cycle can be a multiplicative inverse of the frame rate or less, for example. Alternatively, for the sub camera 400, the CPU 101 may store a total value of the pan angle and the tilt angle controlled from the initial state in the RAM 102 and use it as the current optical axis direction.

The CPU 101 calculates the amount of change in the pan angle and the tilt angle of the sub camera 400 in this manner and stores it in the RAM 102. Note that in the case of a plurality of the sub cameras 400, the CPU 101 calculates the amount of change in the pan angle and the tilt angle per sub camera.

The amount of change in the pan angle and the tilt angle may be set as the angular velocity for turning the sub camera 400 to the direction of the tracking subject. For example, the CPU 101 obtains the current pan angle and tilt angle from the sub camera 400 via the communication network 700. Then, the CPU 101 obtains the pan angular velocity that is proportional to the difference between the pan angle θ read out from the RAM 102 and the current pan angle. Also, the CPU 101 obtains the tilt angular velocity that is proportional to the difference between the tilt angle ρ read out from the RAM 102 and the current tilt angle. The angular velocity calculated in this manner is stored in the RAM 102 by the CPU 101.

Note that the amount of change in the pan angle and the tilt angle may be calculated using the video of the sub camera 400 instead of the video of the overhead camera 300. In this case, the CPU 101 may calculate the amount of change in the pan angle from the difference in the horizontal direction between the current optical axis direction in the coordinate system of the sub camera 400 and the tracking subject direction and calculate the amount of change in the tilt angle from the vertical direction difference. Also, the image capture system may perform a change in the image capture direction for tracking the tracking subject for image capture for only one of the pan direction and the tilt direction, and in such an image capture system, the amount of change may be calculated for only one of the pan angle and the tilt angle.

Next, the operations of the CPU 101 as the zoom value calculation unit 125 will be described. The CPU 101, as the zoom value calculation unit 125, periodically obtains information MAIN_ZOOM indicating the angle of view of the main camera 500 and stores this in the RAM 102. Also, in a case where the information MAIN_ZOOM is changed, the CPU 101 calculates a zoom value Z_VALUE for the sub camera 400 according to the operation control content CAMERA_ROLE in accordance with the role set for the sub camera 400. The format of the control command is predetermined. The CPU 101 stores generated control commands PT_VALUE and Z_VALUE in the RAM 102. Note that in a case where the tracking subject is stationary, where the angle of view of the main camera 500 does not change, and where a control command does not need to be generated, S208 may be skipped. For the sub camera 400 not linked with the main camera 500, a control command for the angle of view may be generated for maintaining the size of the tracking subject or the angle of view may be fixed with a control command for the angle of view not being generated.

Note that the CPU 101 can determine the zoom operation and the phase thereof of the main camera 500 by detecting an angle of view change in the video of the main camera 500, for example. For example, a change in the angle of view may be detected from a change over time in the size of the subject region and gap or the like.

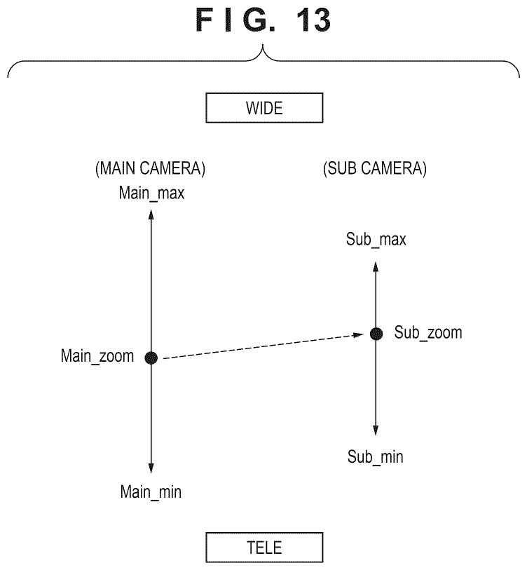

FIG. 13 illustrates a mapping example of zoom values of the main camera and the sub camera. Here, the angle of view of the main camera 500 and the sub camera 400 is optically changed (imaging optical system includes a zoom function). However, a similar function may be implemented via a digital zoom using the image processing unit 406 and an image processing unit 506.

Note that the zoom value is a parameter with a value corresponding to the angle of view. In the present embodiment, the zoom value has a smaller value when the angle of view is small (narrow), and the zoom value on the telephoto side is less than the zoom value on the wide-angle side. The sub camera 400 and the main camera 500 transmit a command designating the zoom value, enabling control of the imaging optical system to the angle of view corresponding to the zoom value. In other words, the zoom value is information relating to the angle of view and representing the zoom state. The zoom value may be the focal length (mm) of the imaging optical system supporting a 35 mm full-sized image sensor, for example, and in this case, the zoom value on the telephoto side is greater than the zoom value on the wide-angle side.

In FIG. 13, the range of the zoom value MAIN_ZOOM of the main camera 500 is from main_min to main_max. Also, the zoom range of the sub camera 400 is from sub_min to sub_max. The main_min and sub_min are zoom values corresponding to the telephoto end of the main camera 500 and the sub camera 400, and main_max and sub_max are zoom values corresponding to the wide-angle end of the main camera 500 and the sub camera 400. In the example illustrated in FIG. 13, the range of the zoom value of the main camera 500 is wider than the range of the zoom value of the sub camera 400 for both the telephoto end and the wide-angle end.

In a case where a zoom value SUB_ZOOM of the sub camera 400 is controlled to be in-phase with the zoom value MAIN_ZOOM of the main camera 500, the CPU 101 calculates the SUB_ZOOM corresponding to the current MAIN_ZOOM using the following Formula 5.

$$SUB\_ZOOM = \frac{MAIN\_ZOOM - main\_min}{main\_max - main\_min} \times ( sub\_max - sub\_min ) \qquad Formula 5$$

On the other hand, in a case where a zoom value SUB_ZOOM of the sub camera 400 is controlled to be in an antiphase with the zoom value MAIN_ZOOM of the main camera 500, the CPU 101 calculates the SUB_ZOOM corresponding to the current MAIN_ZOOM using the following Formula 6. Specifically, the CPU 101 calculates the SUB_ZOOM corresponding to the current MAIN_ZOOM by substituting the SUB_ZOOM calculated using Formula 5 into the right side of the following Formula 6.

$$SUB\_ZOOM = sub\_max - ( SUB\_ZOOM - sub\_min ) \qquad ( Formula 6 )$$

In a case where the main camera 500 performs a digital zoom and the angle of view is controlled by cropping, the CPU 101 can determine the zoom value SUB_ZOOM of the sub camera 400 according to the size of the area cropped by the main camera 500. Specifically, the CPU 101 sets the zoom value SUB_ZOOM to decrease (high magnification) as the size of the range cropped by the main camera 500 decreases and sets the zoom value SUB_ZOOM to increase (low magnification) as the size increases.

Also, the zoom control content associated with the role of the sub camera 400 is not limited to in-phase or antiphase control with respect to the main camera 500. For example, a change in the angle of view of the main camera 500 may correspond to an independent zoom operation being associated with a role. For example, an auto-zoom operation for maintaining a constant size for the tracking subject may be associated with a role. Also, the angle of view of the sub camera 400 may be fixed to a specific angle of view. Various zoom controls can be performed for the sub camera 400 by adding roles for association with these zoom controls to the control content for each role or changing the contents of the zoom control for the roles illustrated in FIG. 4.

Returning to FIG. 6A, in S209, the CPU 101, as the linked operation determination unit 130, transmits the control command calculated in S208 to the sub camera 400. Here, the CPU 101 reads out the control commands PT_VALUE and Z_VALUE from the RAM 102 and transmits them from the network I/F 105 to the sub camera 400 via the communication network 700. The sub camera 400 receives the control commands PT_VALUE and Z_VALUE from the network I/F 405 via the communication network 700.

The CPU 101 executes the processing from S201 for the next frame image of the video of the overhead camera 300. Note that the processing illustrated in FIG. 6A does not need to be executed for every frame.

### Operations of Overhead Camera 300

Next, the operations of the overhead camera 300 will be described with reference to FIG. 6B. The operations described below are implemented by the CPU 301 executing a program.

When the power of the overhead camera 300 is turned on, after each functional block is initialized by the CPU 301, the functional blocks enter an image capture standby state. In the image capture standby state, the CPU 301 may start moving image capture processing for live view display and output image data for display generated by the image processing unit 306 to the image capture control apparatus 100 via the network I/F 305.

In the image capture standby state, the CPU 301 waits to receive a control command from the network I/F 305. When a control command is received, the CPU 301 executes an operation in accordance with the control command. Here, an operation in a case where an image capture command is received as a control command from the image capture control apparatus 100 will be described.

In S301, the CPU 301 receives the image capture command transmitted from the image capture control apparatus 100 from the network I/F 305 via the communication network 700.

Note that in the image capture command, an image capture parameter such as frame rate, resolution, or the like may be designated. Also, a setting relating to processing applied by the image processing unit 306 may be included.

In S302, the CPU 301, in response to receiving the image capture command, starts the moving image capture processing for supply to the image capture control apparatus 100. In the moving image capture processing, a moving image is captured with higher image quality than in the moving image capture processing for the live view display. For example, the resolution of the moving image and/or the image capture frame rate is higher than that of the moving image for live view display. The image processing unit 306 applies processing to the image on the basis of the settings of the moving image for supply to the image capture control apparatus 100. The image processing unit 306 sequentially stores the generated moving image data in the RAM 302.

In S303, the CPU 301 reads out the moving image data from the RAM 302 and transmits the moving image data from the network I/F 305 to the image capture control apparatus 100 via the communication network 700. Thereafter, until a stop image capture control command is received, the processing from image capture to moving image data supply is continued.

### Operations of Main Camera 500

Next, the operations of the main camera 500 will be described with reference to FIG. 6C. The operations described below are implemented by the CPU 501 executing a program.

When the power of the main camera 500 is turned on, after each functional block is initialized by the CPU 501, moving image capture processing for supply to the image capture control apparatus 100 is started. The image processing unit 506 applies processing to the analog image signal obtained from an imaging sensor 507 on the basis of the settings of the moving image for supply to the image capture control apparatus 100. The image processing unit 506 sequentially stores the generated moving image data in a RAM 502. The CPU 501 reads out the moving image data from the RAM 502 and supplies the moving image data from the network I/F 505 to the image capture control apparatus 100 via the communication network 700.

The CPU 501 waits to receive a control command from the network I/F 505 while supplying the moving image data to the image capture control apparatus 100. When a control command is received, the CPU 501 executes an operation in accordance with the control command. Here, an operation in a case where an obtain image capture direction command is received will be described. Note that in a case where the control command PT_VALUE for pan and tilt and the zoom control command Z_VALUE are received, the CPU 501 drives the drive unit 509 according to the commands.

In S501, the CPU 501 receives an obtain image capture direction command from the network I/F 505 via the communication network 700. The CPU 501 stores the received obtain image capture direction command in the RAM 502.

In S502, in response to receiving the obtain image capture direction command, the CPU 501 obtains the current pan angle and tilt angle from the drive unit 509 via a drive I/F 508 and stores these in the RAM 502.

In S503, the CPU 501 reads out the current pan angle and tilt angle from the RAM 502 and transmits them, as the image capture direction information ANGLE, from the network I/F 505 to the image capture control apparatus 100 via the communication network 700.

### Operations of Sub Camera 400

Next, the operations of the sub camera 400 will be described with reference to FIG. 6D. The operations described below are implemented by the CPU 401 executing a program.

When the power of the sub camera 400 is turned on, after each functional block is initialized by the CPU 401, moving image capture processing for supply to the image capture control apparatus 100 is started. The image processing unit 406 applies processing to the analog image signal obtained from an imaging sensor 407 on the basis of the settings of the moving image for supply to the image capture control apparatus 100. The image processing unit 406 sequentially stores the generated moving image data in a RAM 402. The CPU 401 reads out the moving image data from the RAM 402 and supplies the moving image data from the network I/F 405 to the image capture control apparatus 100 via the communication network 700.

The CPU 401 waits to receive a control command from the network I/F 405 while supplying the moving image data to the image capture control apparatus 100. When a control command is received, the CPU 401 executes an operation in accordance with the control command. Here, an operation in a case where the pan and tilt control command PT_VALUE and the zoom control command Z_VALUE are received from the image capture control apparatus 100 will be described.

In S401, the CPU 401 receives the pan and tilt control command PT_VALUE and/or the zoom control command Z_VALUE transmitted from the image capture control apparatus 100 from the network I/F 405 via the communication network 700. The CPU 401 stores the received control command in the RAM 402.

In S402, the CPU 401 reads out the operation amount corresponding to the operation direction from the control command stored in the RAM 402 and stores this in the RAM 402. Here, in the case of the pan and tilt control command PT_VALUE, the operation direction is the direction of the pan and/or tilt direction and the operation amount is the target angle. Also, in the case of the zoom control command Z_VALUE, the operation amount is the zoom value, and there is no need to read out and store the operation direction for identifying the operation direction from the zoom value.

In S403, the CPU 401 generates a drive parameter of the drive unit 409 on the basis of the operation direction and operation amount read out in S402. The CPU 401 may obtain the drive parameter for the combination of the operation direction and the operation amount using a table stored in a ROM 403 in advance, for example. Note that in a case where the operation amount is provided as a target value (target angle or zoom value), the CPU 401 obtains the drive parameter from the difference with the current value.

In S404, the CPU 401 controls the drive unit 409 via the drive I/F 408 on the basis of the drive parameter obtained in S403. Accordingly, the drive unit 409 changes the image capture direction of the sub cameras 400 to the operation direction and the angle designated by the pan and tilt control command PT_VALUE. Also, the drive unit 409 changes the angle of view of the imaging optical system to the zoom value designated by the zoom control command Z_VALUE.

Next, as an example of a method for determining whether or not to link the sub camera 400 with the main camera 500, in S206 of FIG. 6A, a determination method based on the streaming status of the main camera 500 will be described.

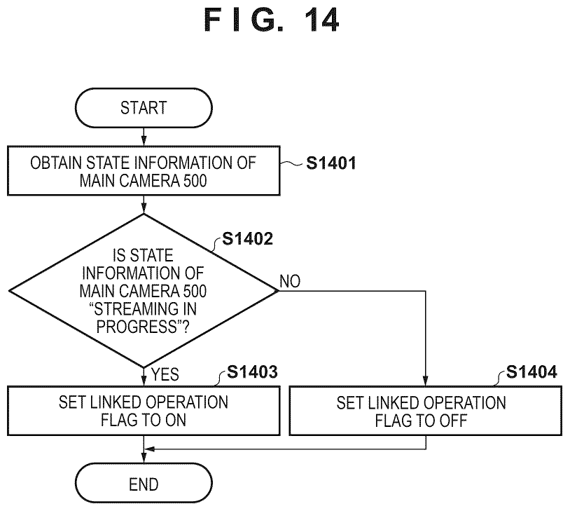

FIG. 14 is a flowchart illustrating the operations of the CPU 101 as the linked operation determination unit 130. In the present embodiment, basically, the image capture control apparatus 100 automatically controls the image capture direction and the angle of view of the sub camera 400 linked with the movement of the main camera 500. However, in a case where the video selected by the switcher 1000 is switched from the video of the main camera 500 to the video of the sub camera 400, undesired automatic control of the sub camera 400 may occur.

For example, based on the switcher 1000 no longer selecting the video of the main camera 500 ends, the user operating the main camera 500 may greatly change the image capture direction and/or the angle of view in order to find the next subject to capture, for example. When linking a sub camera 400 to such operations of the main camera 500 that assume the video of main camera 500 is not being selected, the video of the sub camera 400 being selected by the switcher 1000 may be inappropriate to use in streaming and the like. Note that this is not limited to cases in which a user directly operates the main camera 500 and may also occur in cases of remote control.

On the other hand, in a case where the video of the main camera 500 is selected by the switcher 1000, because the user of the main camera 500 understands that the video being captured is being used in streaming or the like, the user tries not to greatly change the image capture direction and the angle of view. In this case, there is no problem in linking the sub camera 400 with the main camera 500.

Thus, in S206, the CPU 101 can determine whether or not to perform automatic control so that the sub camera 400 links with the main camera 500 depending on whether or not the video of the main camera 500 is a video being streamed.

In S1401, the CPU 101, as the linked operation determination unit 130, obtains the state information of the main camera 500. The CPU 101 obtains the current camera state information STREAMING stored in the RAM 1002 from the switcher 1000 and extracts the state information of the main camera 500. Alternatively, the CPU 101 may obtain the state information directly from the main camera 500 to reduce the communication amount between the switcher 1000 and the image capture control apparatus 100. Also, as described above, as the camera state information of the main camera 500, tally information for the main camera 500 may be obtained from the switcher 1000 or the main camera 500. The CPU 101 stores the obtained state information in the RAM 102.

In S1402, the CPU 101 determines whether or not the state information (tally information) of the main camera 500 obtained in S1401 is “streaming in progress”. If “streaming in progress” is determined, S1403 is executed, and if “streaming in progress” is not determined, S1401 is executed. Note that in a case where the tally information is obtained in S1401, the CPU 101 determines whether or not the tally information for the main camera 500 is “streaming in progress”.

In S1403, the CPU 101 sets the linked operation flag stored in the RAM 102 to on. This corresponds to determining to link the sub camera 400 with the main camera 500. In a case where the linked operation flag is on, the sub cameras 400 are linked with the main camera 500 according to its role, and a control command for automatic control is transmitted to the sub camera 400.

In S1404, the CPU 101 sets the linked operation flag stored in the RAM 102 to off. This corresponds to determining to not link the sub camera 400 with the main camera 500. In a case where the linked operation flag is off, a control command for the sub camera 400 to continue to track the currently tracked subject for image capture is transmitted to the sub camera 400 while the current angle of view is maintained by the CPU 101.

In this manner, in the present embodiment, whether or not to link the sub camera 400 with the main camera 500 is determined on the basis of whether or not the video of the main camera 500 is selected by the switcher 1000. Then, automatic control in the case of linking the sub camera 400 to the main camera 500 and automatic control in the case of not linking is selectively executed.

In a case where the video of the main camera 500 is not selected by the switcher 1000, there is a possibility of a rapid change in the image capture direction and the angle of view of the main camera 500. Thus, the CPU 101 performs control so that the sub cameras 400 are not linked with the main camera 500 and continues to track the current tracking subject for image capture. On the other hand, in a case where the video of the main camera 500 is selected by the switcher 1000, the possibility of a rapid change in the image capture direction and the angle of view of the main camera 500 is considered to be sufficiently low. Thus, the CPU 101 performs control to link the image capture operation of the sub camera 400 with the main camera 500. Accordingly, video of a high quality can be stably provided even in a case where the sub camera 400 is operated unmanned and the video of the sub camera 400 is selected by the switcher 1000.

Note that also in a case where the state information of the main camera 500 is “preview in progress”, the sub camera 400 may not be linked with the main camera 500 in a similar manner to when the state information is “streaming in progress”. Also, instead of the camera state information STREAMING, the tally information output by the tally signal output unit 1010 may be used to determine whether or not the video of the main camera 500 is selected by the switcher 1000.

### Second Embodiment

Next, the second embodiment of the present disclosure will be described. In the present embodiment, as another example of a method for determining whether or not to link the sub camera 400 with the main camera 500, in S206 of FIG. 6A, a determination method based on PTZ speed information of the main camera 500 will be described.

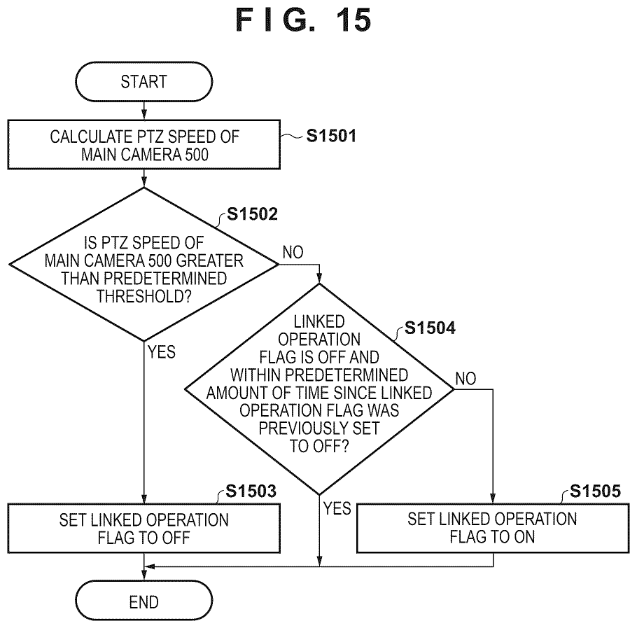

FIG. 15 is a flowchart illustrating the operations of the CPU 101 as the linked operation determination unit 130 according to the present embodiment.

As described above, the CPU 101, as the linked operation determination unit 130, periodically obtains the information ANGLE and the information MAIN_ZOOM from the main camera 500. In S1501, on the basis of this information, the CPU 101 calculates the pan, tilt, and zoom speed (PTZ speed) on the basis of the information obtaining period and the amount of change and stores this in the RAM 102.

In S1502, the CPU 101 reads out the PTZ speed of the main camera 500 from the RAM 102 and determines whether or not it is greater than a predetermined threshold. The predetermined threshold is a value greater than the speed of a zoom, pan, or tilt operation in a typical video presentation. If the CPU 101 determines that the speed of each of the pan, tilt, and zoom is not greater than the predetermined threshold, the CPU 101 executes S1503. If otherwise is determined, the CPU 101 executes S1504.

Note that in S1502, instead of the predetermined threshold, the average speed in a predetermined time period or the number of rapid changes in speed may be used. A rapid change may include, for example, the difference between the minimum value and the maximum value of the speed per predetermined unit time shorter than a certain time period or the change in speed over time exceeding a predetermined threshold. Accordingly, in a case where the number of rapid PTZ operations of the main camera 500 is greater than the threshold, for example, control can be performed to not link the sub camera 400 to the main camera 500 or the like.

In S1503, the CPU 101 sets the linked operation flag stored in the RAM 102 to off and ends the processing.

In S1504, the CPU 101 determines whether the current linked operation flag is off, and it is within a predetermined amount of time since the linked operation flag was previously set to off. In the case of these conditions being satisfied, the PTZ speed of the main camera 500 is equal to or less than the threshold but operation has not yet stabilized. Thus, the sub camera 400 is not linked with the main camera 500. Accordingly, if the CPU 101 determines that these conditions are satisfied, the previous linked operation flag is left set to off and the processing ends. On the other hand, if the CPU 101 determines that the current linked operation flag is not off or a predetermined amount of time has been exceeded since the linked operation flag was previously set to off, the CPU 101 executes S1505.

In S1505, the CPU 101 sets the linked operation flag to on if it is off and ends the processing. In other words, in S1505, the CPU 101 determines to link the sub camera 400 to the main camera 500. Even if the linked operation flag is off, if the elapsed time from when the PTZ speed of the main camera 500 became equal to or less than the threshold is greater than a predetermined amount of time, there is a high possibility that operations have stabilized. Thus, the CPU 101 determines to link the sub camera 400 to the main camera 500.

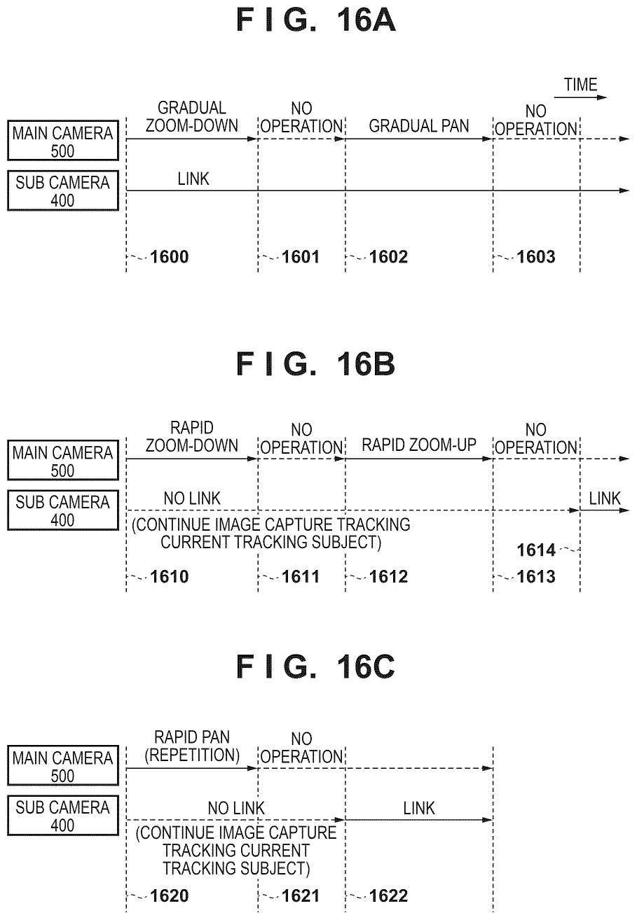

FIGS. 16A to 16C are timing charts illustrating examples of determination in S206 according to the PTZ speed of the main camera 500.

FIG. 16A illustrates an example of a timing chart in a case where a gradual zoom-down and pan operation is performed with the main camera 500. As the presentation of the video, for example, the subject may be gradually zoomed down on and a gradual pan operation may be performed to capture another subject located ahead of the line-of-sight of the subject. In this case, control is performed to change the image capture direction and the angle of view of the sub camera 400 gradually in a similar manner to the PTZ speed of the main camera 500 even if the sub camera 400 is linked with the main camera 500. Thus, no problems with the video quality of the sub camera 400 occur. Accordingly, the user of the switcher 1000 can select the video of the sub camera 400 as the preview video. Thus, in the example of FIG. 16A, since the sub camera 400 is linked with the main camera 500, no user is required for the sub camera 400.

The relationship between the timing chart of FIG. 16A and the steps in the flowchart of FIG. 15 will now be described. Here, in the initial status, automatic control (linked operation flag on) is performed with the sub camera 400 linked to the main camera 500.

At time 1600, the user of the main camera 500 starts a gradual zoom-down operation. For this operation, in a case where it is determined that the PTZ speed is not greater than the predetermined threshold in S1502 of FIG. 15, S1504 is executed. Since the linked operation flag is on, S1505 is executed and the linked operation flag is left unchanged as on. As a result, automatic control linking the sub camera 400 to the main camera 500 is continued.

At time 1601, zoom-down ends, and the user of the main camera 500 maintains the image capture direction and the angle of view. Since the PTZ speed is 0, it is determined in S1502 that the PTZ speed is not greater than the predetermined threshold, and S1504 is executed. Since the linked operation flag is on, S1505 is executed and the linked operation flag is left unchanged as on. As a result, automatic control linking the sub camera 400 to the main camera 500 is continued.

At time 1602, the user of the main camera 500 starts a gradual pan operation. It is determined in S1502 that the PTZ speed is not greater than the predetermined threshold, and S1504 is executed. Since the linked operation flag is on, S1505 is executed and the linked operation flag is left unchanged as on. As a result, automatic control linking the sub camera 400 to the main camera 500 is continued.

At time 1603, the pan operation ends, and the user of the main camera 500 maintains the image capture direction and the angle of view. Since the PTZ speed is 0, it is determined in S1502 that the PTZ speed is not greater than the predetermined threshold, and S1504 is executed. Since the linked operation flag is on, S1505 is executed and the linked operation flag is left unchanged as on. As a result, automatic control linking the sub camera 400 to the main camera 500 is continued.

FIG. 16B illustrates an example of a timing chart in a case where a rapid zoom-down and zoom-up is performed with the main camera 500. For example, such a zoom operation may be performed when the user of the main camera 500 is trying to quickly find another main subject.

The relationship between the timing chart of FIG. 16B and the steps in the flowchart of FIG. 15 will now be described. Here, in the initial status, automatic control (linked operation flag on) is performed with the sub camera 400 linked to the main camera 500.

At time 1610, the user of the main camera 500 starts a rapid zoom-down operation. For this operation, in a case where it is determined that the PTZ speed is greater than the predetermined threshold in S1502, in S1503, the linked operation flag is set to off. As a result, the sub cameras 400 are not linked with the main camera 500, and automatic control is started to continue to track the current tracking subject.

At time 1611, the user of the main camera 500 finds a subject to focus on next from a wide-angle video and thus stops operation. Accordingly, it is determined in S1502 that the PTZ speed is not greater than the predetermined threshold, and S1504 is executed. Since the elapsed time from when the linked operation flag was set to off is within a predetermined amount of time, S1505 is not executed and the linked operation flag is left unchanged as off.

At time 1612, the user of the main camera 500 starts a rapid zoom-up operation for the next main subject candidate. Since it is determined that the PTZ speed is greater than the predetermined threshold in S1502, S1503 is executed, but since the linked operation flag is off, this is not changed.

At time 1613, the zoom-up operation ends, and the user of the main camera 500 maintains the image capture direction and the angle of view. Since the PTZ speed is 0, it is determined in S1502 that the PTZ speed is not greater than the predetermined threshold, and S1504 is executed. Since the elapsed time from when the linked operation flag was set to off is within a predetermined amount of time, S1505 is not executed and the linked operation flag is left unchanged as off.

The image capture direction and the angle of view of the main camera 500 continue to be maintained, and at time 1614, the elapsed time from when the linked operation flag was set to off is greater than the predetermined amount of time. It is determined in S1502 that the PTZ speed is not greater than the predetermined threshold, and S1504 is executed. In S1504, since the elapsed time from when the linked operation flag was set to off is greater than the predetermined amount of time, S1505 is executed and the linked operation flag is set to on. Accordingly, automatic control is started to perform image capture operations with the sub camera 400 linked to the main camera 500.

FIG. 16C illustrates an example of a timing chart in a case where a rapid pan operation with the main camera 500 is repeatedly performed. For example, such a pan operation may be performed when the user of the main camera 500 is trying to quickly find another main subject.

The relationship between the timing chart of FIG. 16C and the steps in the flowchart of FIG. 15 will now be described. Here, in the initial status, automatic control (linked operation flag on) is performed with the sub camera 400 linked to the main camera 500.

At time 1620, the user of the main camera 500 repeats a rapid pan operation. For this operation, in a case where it is determined that the PTZ speed is greater than the predetermined threshold in S1502, in S1503, the linked operation flag is set to off. As a result, the sub cameras 400 are not linked with the main camera 500, and automatic control is started to continue to track the current tracking subject.

At time 1621, the user of the main camera 500 finds a subject to focus on next and thus stops operation. Accordingly, it is determined in S1502 that the PTZ speed is not greater than the predetermined threshold, and S1504 is executed. Since the elapsed time from when the linked operation flag was set to off is within a predetermined amount of time, S1505 is not executed and the linked operation flag is left unchanged as off.

The image capture direction and the angle of view of the main camera 500 continue to be maintained, and at time 1622, the elapsed time from when the linked operation flag was set to off is greater than the predetermined amount of time. It is determined in S1502 that the PTZ speed is not greater than the predetermined threshold, and S1504 is executed. In S1504, since the elapsed time from when the linked operation flag was set to off is greater than the predetermined amount of time, S1505 is executed and the linked operation flag is set to on. Accordingly, automatic control is started to perform image capture operations with the sub camera 400 linked to the main camera 500.

In this manner, in the present embodiment, whether or not to link a sub camera with a main camera is determined on the basis of the PTZ speed of the main camera 500. For example, in a case where the PTZ speed of the main camera 500 is greater than the predetermined threshold, for example, there is a possibility that the next main subject is being looked for or a similar action not taking into consideration the quality of the video. Thus, the CPU 101 performs control so that the image capture operation of the sub cameras 400 are not linked with the main camera 500 and continues to track the current tracking subject for image capture. On the other hand, in a case where the PTZ speed of the main camera 500 is not greater than the predetermined threshold, the CPU 101 performs control to link the image capture operation of the sub camera 400 with the main camera 500. Accordingly, video of a high quality can be stably provided even in a case where the sub camera 400 is operated unmanned.

### Third Embodiment

Next, the third embodiment of the present disclosure will be described. In the present embodiment, as yet another example of a method for determining whether or not to link the sub camera 400 with the main camera 500, in S206 of FIG. 6A, a determination method based on the place being captured by the main camera 500 will be described.

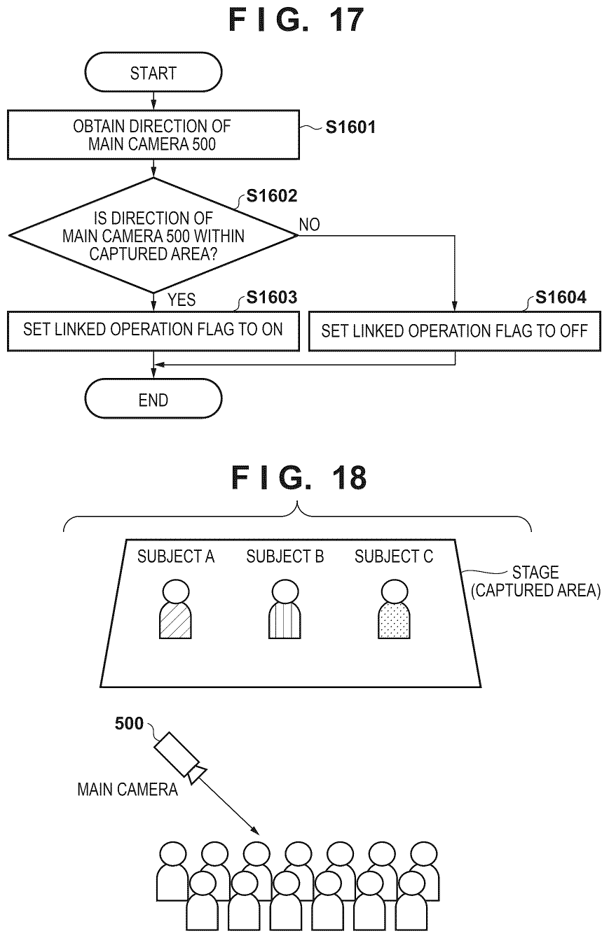

FIG. 17 is a flowchart illustrating the operations of the CPU 101 as the linked operation determination unit 130 according to the present embodiment.

In the present embodiment, it is assumed that the user has designated a specific area (here, defined as a captured area) with respect to the overhead camera 300 via the user input unit 106. Also, the captured area information is stored in the RAM 102.

In S1601, the CPU 101, as the linked operation determination unit 130, obtains the information ANGLE indicating the image capture direction from the main camera 500 and stores this in the RAM 102.

In S1602, the CPU 101 reads out the captured area information and the information ANGLE from the RAM 102 and determines whether or not the image capture direction of the main camera 500 is within the captured area.

FIG. 18 is a schematic view illustrating an example of a situation in which the image capture direction of the main camera 500 is outside the captured area. In the illustrated example, the main camera 500 is capturing an image of the audience seating. In live broadcasts, the user of the main camera 500 may capture images with video of the audience being intentionally placed between video of the stage. In such cases, since the main subject and the angle of view of the main camera 500 frequently change, the sub camera 400 is preferably not linked with the main camera 500.

Returning to FIG. 17, in S1602, if the CPU 101 determines that the image capture direction of the main camera 500 is oriented to a point inside the captured area, S1603 is executed. If the CPU 101 determines otherwise, S1604 is executed.

In S1603, the CPU 101 sets the linked operation flag stored in the RAM 102 to on. In other words, the CPU 101 determines to link the sub camera 400 to the main camera 500.

In S1604, the CPU 101 sets the linked operation flag stored in the RAM 102 to off. In other words, the CPU 101 determines not to link the sub camera 400 to the main camera 500.

Note that in the present embodiment, whether or not the main camera 500 is capturing an image of the captured area is determined on the basis of the captured area information and the image capture direction of the main camera 500. However, another method may be used for the determination. For example, captured area detection processing using a machine learning model or the like may be executed on the video of the main camera 500 to determine whether or not the main camera 500 is capturing an image of the captured area. With this method, there is no need to set the captured area in advance.

In the present embodiment, in a case where the main camera 500 is not capturing an image of the predetermined captured area, control is performed so that the sub cameras 400 are not linked with the main camera 500 and the current tracking subject is continued to be tracked for image capture. On the other hand, in a case where the main camera 500 is capturing an image of the captured area, the sub camera 400 is linked with the main camera 500. Accordingly, video of a high quality can be stably provided even in a case where the sub camera 400 is operated unmanned.

### Fourth Embodiment

Next, the fourth embodiment of the present disclosure will be described. The present embodiment relates to yet another example of a method for determining whether or not to link the sub camera 400 with the main camera 500, in S206 of FIG. 6A. Specifically, the present embodiment relates to a determination method based on whether or not the main camera 500 has been capturing images of the same subject as the main subject continuously for a predetermined amount of time.

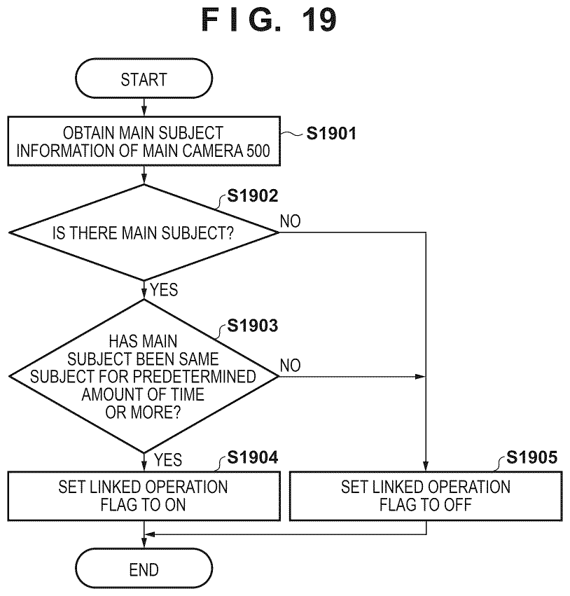

FIG. 19 is a flowchart illustrating the operations of the CPU 101 as the linked operation determination unit 130 according to the present embodiment.

In S1901, the CPU 101, as the linked operation determination unit 130, obtains the identification information MAIN_SUBJECT of the main subject from the main subject determination unit 122 and stores this in the RAM 102. As described above, the identification information MAIN_SUBJECT stores information that can identify the subject via a method using template matching.

In S1902, the CPU 101 reads out the identification information MAIN_SUBJECT from the RAM 102 and determines whether or not the main subject is there. For example, in a case where the main camera 500 captures the captured area in a wide-angle and all of the subjects are shown at a predetermined size or smaller, it is determined that there is no main subject. Also, in a case where the main subject is detected but is not present at a predetermined position (for example, in the center) on the screen, it may be determined that there is no main subject. For example, in a case where the user of the main camera 500 is trying to capture the main subject in the center of the screen, since the composition is not yet set when the main subject is not positioned in the center of the screen, linking of the sub camera 400 may not be performed. If the CPU 101 determines that there is a main subject, S1903 is executed. If otherwise is determined, S1905 is executed.

In S1905, the CPU 101 sets the linked operation flag stored in the RAM 102 to off. In other words, the CPU 101 determines not to link the sub camera 400 to the main camera 500.

In S1903, the CPU 101 determines whether or not the main camera 500 has been capturing images of the same subject continuously for a predetermined amount of time or more. Specifically, the CPU 101 reads out the identification information MAIN_SUBJECT from the RAM 102 and determines whether or not the main subject indicated in the identification information MAIN_SUBJECT has not changed for a predetermined amount of time or more. The predetermined amount of time is set as the amount of time needed to consider that the user of the main camera 500 has confirmed the main subject.

Each time the main subject is determined in S204 of FIG. 6A, the CPU 101 stores the history of the identification information MAIN_SUBJECT in the RAM 102. In S1903, for example, in a case where the same identification information MAIN_SUBJECT has been consecutively stored in the RAM 102 a predetermined number of times or more, the CPU 101 determines that the main camera 500 has been capturing the same subject continuously for the predetermined amount of time or more. Note that if the identification information MAIN_SUBJECT and the current time are associated together and stored, and the main subject has not changed for a predetermined amount of time, the CPU 101 may determine that the main camera 500 has been capturing the same subject continuously for the predetermined amount of time or more.

These determination methods are examples, and other methods may be used. As in S1902, the position of the main subject in the screen may be taken into consideration in the determination. In other words, in a case where the same subject has been present continuously at a predetermined position on the screen for a predetermined amount of time or more, it may be determined that the main camera 500 has been capturing the same subject continuously for the predetermined amount of time or more. In a case where the same subject has been present on the screen continuously for a predetermined amount of time or more but the position on the screen varies, since composition is not set, linking of the sub camera 400 may not be performed.

If the CPU 101 determines that the main camera 500 has been capturing images of the same subject continuously for the predetermined amount of time, S1904 is executed. If otherwise is determined, S1905 is executed.

In S1904, the CPU 101 sets the linked operation flag stored in the RAM 102 to on. In other words, the CPU 101 determines to link the sub camera 400 to the main camera 500.

In S1905, the CPU 101 sets the linked operation flag stored in the RAM 102 to off. In other words, the CPU 101 determines not to link the sub camera 400 to the main camera 500.

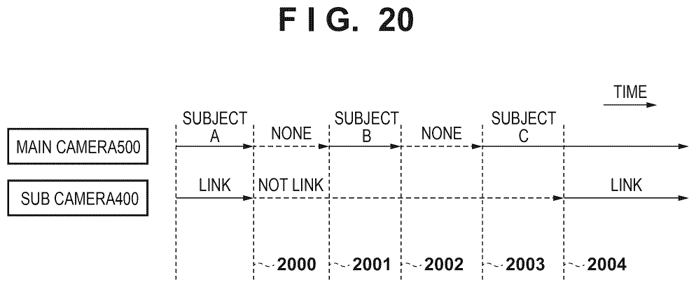

FIG. 20 is a timing chart illustrating an example of the determination in S206 in accordance with whether or not there is a change in the main subject of the main camera 500. The relationship between the timing chart of FIG. 20 and the steps of the flowchart of FIG. 19 will be described below. Here, in the initial status, automatic control (linked operation flag on) is performed with the sub camera 400 linked to the main camera 500.

Initially, the main camera 500 is capturing images of the subject A as the main subject. The switcher 1000 is selecting and outputting the video of the main camera 500. In other words, the state information (tally information) of the main camera 500 is “streaming in progress”. Automatic control is being performed so that image capture is performed with the sub camera 400 linked with the main camera 500 according to its role.

At time 2000, the switcher 1000 selects the video of the sub camera 400. Also, due to the video of the main camera 500 being unselected, the user of the main camera 500 starts an operation for changing the main subject. For example, the user of the main camera 500 may rapidly zoom-down and capture an image of the entire stage and, while looking at the wide-angle video, find the next main subject.

In a case where the CPU 101 determines that the PTZ speed of the main camera 500 is greater than the predetermined threshold as described in the second embodiment, for example, the CPU 101 determines that there is no main subject in S1902. Note that in S1902, another method may be used in the determination such as the CPU 101 determining that there is no main subject on the basis of the main subject up until time 2000 becoming unable to be detected from the video of the main camera 500. As a result, in S1905, the linked operation flag is set to off, and the content of the automatic control is changed so that image capture is performed with the sub camera 400 not linked with the main camera 500.

At time 2001, after the user of the main camera 500 has rapidly zoomed up on the subject B, zoomed up image capture of the subject B starts without a rapid operation being performed. Accordingly, the CPU 101 determines in S1902 that there is a main subject (subject B). However, since a predetermined amount of time has not passed since the subject B became the main subject, the determination of S1903 is no, and the CPU 101 executes S1905. As a result, the linked operation flag remains set to off.

At time 2002 before the predetermined amount of time has passed from time 2001, when the user of the main camera 500 performs a rapid zoom-down operation again, the CPU 101 determines that there is no main subject in S1902, and thus the linked operation flag remains set to off. Since no main subject is determined before the predetermined amount of time has passed from when the subject B became the main subject at time 2001, image capture operation is continued with the sub camera 400 still not linked with the main camera 500.

At time 2003, after the user of the main camera 500 has rapidly zoomed up on a subject C, zoomed up image capture of the subject C starts without a rapid operation being performed. Accordingly, the CPU 101 determines in S1902 that there is a main subject (subject C). However, since a predetermined amount of time has not passed since the subject C became the main subject, the determination of S1903 is no, and the CPU 101 executes S1905. As a result, the linked operation flag remains set to off.

Even at time 2004 after a predetermined amount of time has passed from time 2003, since the main subject of the main camera 500 is still the subject C, the CPU 101 determines in S1903 that the main camera 500 has captured the same subject continuously for the predetermined amount of time or more. Accordingly, in S1904, the CPU 101 sets the linked operation flag to on. As a result, the content of the automatic control is changed so that image capture is performed with the sub camera 400 linked to the main camera 500.

Note that in the present embodiment, whether or not the main camera 500 has been capturing the same main subject continuously for the predetermined amount of time is determined on the basis of the identification information MAIN_SUBJECT. The identification information MAIN_SUBJECT indicates the main subject of the main camera 500 determined on the basis of the video of the overhead camera 300 and the image capture direction of the main camera 500. However, another method may be used to determine whether or not the main camera 500 has been capturing the same main subject continuously for the predetermined amount of time. For example, main subject detection processing using a machine learning model or the like may be executed on the video of the main camera 500, and whether or not the main camera 500 has been capturing the same main subject continuously for the predetermined amount of time may be determined on the basis of the detection result. In this case, the presence of the main subject can also be determined using the result of the main subject detection processing. In this case, the main subject can be detected from the video of the main camera 500 without the image capture direction of the main camera 500 being obtained.

In the present embodiment, in a case where the main camera 500 has not been capturing the same main subject continuously for the predetermined amount of time, control is performed so that the sub cameras 400 are not linked with the main camera 500 and the current tracking subject is continued to be tracked for image capture. On the other hand, in a case where the main camera 500 has been capturing the same main subject continuously for the predetermined amount of time, the sub camera 400 is linked with the main camera 500. Accordingly, video of a high quality can be stably provided even in a case where the sub camera 400 is operated unmanned.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-229384, filed Dec. 25, 2024, which is hereby incorporated by reference herein in its entirety.

What is claimed is:

1. An image capture control apparatus that controls an image capture operation of a sub camera from among a plurality of cameras including a main camera and one or more sub cameras, comprising:
one or more processors that execute a program stored in a memory, wherein the program includes instructions that, when the program is executed by the one or more processors, cause the one or more processors to:
selectively execute, based on information relating to the main camera, first control including automatically controlling one or more of an image capture direction and an angle of view of a sub camera based on a state of the main camera or a video captured by the main camera, and second control including automatically controlling one or more of the image capture direction and the angle of view of the sub camera not based on the state of the main camera and the video captured by the main camera.

2. The image capture control apparatus according to claim 1, wherein
the information relating to the main camera includes information indicating whether the video captured by the main camera is selected by an external apparatus, and
the instructions cause the one or more processors to execute the first control in a case where the external apparatus is selecting the video captured by the main camera, and execute the second control in a case where the external apparatus is not selecting the video captured by the main camera.

3. The image capture control apparatus according to claim 2, wherein
the external apparatus is a video switcher that outputs a video selected from among videos captured by the plurality of cameras.

4. The image capture control apparatus according to claim 3, wherein
the instructions cause the one or more processors to determine whether the external apparatus is selecting the video captured by the main camera, based on tally information supplied to the plurality of cameras by the video switcher.

5. The image capture control apparatus according to claim 1, wherein
the information relating to the main camera includes information indicating a speed of pan, tilt, and zoom of the main camera, and
the instructions cause the one or more processors to execute the second control in a case where the speed is greater than a predetermined threshold, and execute the first control in a case where the speed is not greater than the predetermined threshold.

6. The image capture control apparatus according to claim 1, wherein
the information relating to the main camera includes information indicating a speed of one or more of pan, tilt, and zoom of the main camera, and
the instructions cause the one or more processors to execute the second control in a case where a count, which indicates a total number of times a change over time of the speed of one or more of pan, tilt, and zoom exceeds a predetermined threshold in a predetermined time period, is greater than a threshold, and execute the first control in a case where the count is not greater than the threshold.

7. The image capture control apparatus according to claim 1, wherein
the information relating to the main camera includes information indicating an image capture direction of the main camera, and
the instructions cause the one or more processors to execute the first control in a case where the image capture direction is oriented to a point inside a captured area determined in advance, and execute the second control in a case where the image capture direction is not oriented to a point inside the captured area.

8. The image capture control apparatus according to claim 1, wherein
the information relating to the main camera includes information relating to a main subject of the main camera, and
the instructions cause the one or more processors to execute the first control in a case where it is determined that the main subject is present in the video captured by the main camera, and execute the second control in a case where it is determined that the main subject is not present in the video captured by the main camera.

9. The image capture control apparatus according to claim 8, wherein
a case where it is determined that the main subject is not present in the video captured by the main camera includes a case where a size of each subject in the video captured by the main camera is a predetermined size or less.

10. The image capture control apparatus according to claim 8, wherein
a case where it is determined that the main subject is not present in the video captured by the main camera includes a case where the main subject is not present at a predetermined position in the video captured by the main camera.

11. The image capture control apparatus according to claim 1, wherein
the information relating to the main camera is information relating to a main subject of the main camera, and
the instructions cause the one or more processors to execute the first control in a case where the main camera has been capturing a same main subject continuously for a predetermined amount of time or more, and execute the second control in a case where the main camera has not been capturing a same main subject continuously for the predetermined amount of time or more.

12. The image capture control apparatus according to claim 11, wherein
the instructions cause the one or more processors to execute the second control in a case where, in the video captured by the main camera, the main subject has not been present at a predetermined position for the predetermined amount of time or more.

13. The image capture control apparatus according to claim 1, wherein
the instructions cause the one or more processors to, when changing automatic control of a sub camera from the first control to the second control, perform, in the second control, automatic control of the image capture operation of the sub camera so as to continue to track a subject previously tracked in execution of the first control.

14. The image capture control apparatus according to claim 1, wherein
the instructions cause the one or more processors to, in a case where the first control is executed, perform automatic control of the image capture operation of a sub camera according to a role set for the sub camera.

15. The image capture control apparatus according to claim 14, wherein
the role defines one or more of:
a relationship between a subject tracked in image capture performed by the sub camera and a main subject of the main camera; and
a relationship between a zoom operation of the sub camera and a zoom operation of the main camera.

16. A multi-camera image capture system, comprising:
a plurality of cameras including a main camera and one or more sub cameras; and
an image capture control apparatus that controls an image capture operation of a sub camera from among the plurality of cameras,
wherein the image capture control apparatus comprises:
one or more processors that execute a program stored in a memory, wherein the program includes instructions that, when the program is executed by the one or more processors, cause the one or more processors to:
selectively execute, based on information relating to the main camera, first control including automatically controlling one or more of an image capture direction and an angle of view of a sub camera based on a state of the main camera or a video captured by the main camera, and second control including automatically controlling one or more of the image capture direction and the angle of view of the sub camera not based on the state of the main camera and the video captured by the main camera.

17. A control method executed by an image capture control apparatus that controls an image capture operation of a sub camera from among a plurality of cameras including a main camera and one or more sub cameras, comprising:
performing automatic control of one or more of an image capture direction and an angle of view of the sub camera, wherein
the automatic control includes selectively executing, based on information relating to the main camera, first control including automatically controlling one or more of an image capture direction and an angle of view of a sub camera based on a state of the main camera and a video captured by the main camera, and second control including automatically controlling one or more of the image capture direction and the angle of view of the sub camera not based on the state of the main camera and the video captured by the main camera.

18. A non-transitory computer-readable storage medium which stores a program for causing a computer to execute a control method of an image capture control apparatus that controls an image capture operation of a sub camera from among a plurality of cameras including a main camera and one or more sub cameras, wherein the method comprising:
performing automatic control of one or more of an image capture direction and an angle of view of the sub camera, wherein
the automatic control includes selectively executing, based on information relating to the main camera, first control including automatically controlling one or more of an image capture direction and an angle of view of a sub camera based on a state of the main camera and a video captured by the main camera, and second control including automatically controlling one or more of the image capture direction and the angle of view of the sub camera not based on the state of the main camera and the video captured by the main camera.
